(19) United States
(12) Patent Application Publication
(10) Pub. No.: US 2024/0311943 A1
(43) Pub. Date: Sep. 19, 2024

(54) APPARATUS AND METHODS FOR POINT-TO-POINT TRANSPORTATION

(71) Applicant: Goran SPASOVSKI, Belgrade (RS)

(72) Inventor: Goran SPASOVSKI, Belgrade (RS)

(21) Appl. No.: 18/274,730

(22) PCT Filed: Jan. 5, 2022
(86) PCT No.: PCT/RS2022/000001

§ 371 Date: Jul. 28, 2023

(51) Int. Cl. G06Q 50/40; G06Q 10/1093; G08G 1/00

(52) U.S. Cl. CPC G06Q 50/40; G06Q 10/1093; G08G 1/202

(57) ABSTRACT

Centrally controlled smart transportation systems can provide point-to-point transportation of people and goods. The systems may be configured to allocate tunneled routes to individual vehicles. Travel of different vehicles can be coordinated so that vehicles can cross level intersections without stopping and without collisions. A transportation system may include a hierarchical network of controllers that control individual vehicles to maintain allowed positions that have been reserved for the vehicles in traffic streams.

### TECHNICAL FIELD

The present invention relates generally to transportation systems for transporting persons and/or goods between source locations and destination locations. The inventions may be applied to the central control of a fleet of individually routed vehicles on a system of dedicated roadways.

### BACKGROUND

Providing transportation in densely populated areas is a significant problem. Too many people driving individual cars can lead to congestion. Mistakes made by human drives can lead to accidents which can cause injury or death as well as traffic jams. Providing parking for vehicles that are not currently in use and providing roadways large enough to accommodate vehicle traffic takes up valuable land.

Public transportation by buses, trains, subways or the like addresses some of the problems associated with individual cars but create others. Depending on the source and destination it can take a long time to make a trip on public transit systems. Also, it is difficult for people to take much in the way of shopping or other items when travelling by public transport.

Point-to-point services such as taxis or ride sharing companies (e.g. Uber or Lyft) offer convenience but are expensive and can be unavailable at certain times. These services also increase congestion on the roads.

Autonomous vehicles may eventually be widely available to carry people and their goods from point to point but can still create significant congestion.

There is a strong need for a better way to provide transportation for people and goods, especially in densely populated areas.

### SUMMARY

This invention has a number of aspects. There is synergy in combining any two or more of these aspects. However, these aspects can also be applied individually and in other contexts. These aspects include without limitation:
smart transportation systems which provide point-to-point transportation for persons and/or goods on-demand by a fleet of centrally controlled vehicles.
methods and apparatus for coordinating travel of vehicles across intersections in a smart transportation system.
methods and apparatus for generating routes for vehicles in a fleet of centrally controlled vehicles.
methods and apparatus for collision avoidance in fleets of centrally controlled vehicles.
methods and apparatus for passing off control of vehicles among a network of local controllers.
methods and apparatus for on the fly modification of networks of local controllers.
road networks for controlled vehicles.

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a centrally controlled transportation system. The transportation system comprises vehicles travelling on a system of interconnected roads, each vehicle travelling according to a locked route which is pre-defined by the centrally controlled transportation system. Vehicles travelling on the roads may occupy allowed positions. Adjacent allowed positions are separated by forbidden positions. The positions (and corresponding vehicles) advance along roads according to common time steps, for example, time steps regulated by a master clock. A “field” representing a repeating sequence of allowed and forbidden positions may, for example, be four positions, or units, long. The field may comprise one allowed position followed by three forbidden positions. In some embodiments, a cycle time step for a field to occupy the same position presently occupied by a subsequent field is about one second.

The centrally controlled transportation system may employ the concept of a nominal system velocity wherein velocities of vehicles travelling on roads of the system are defined in relation to the nominal system velocity. As an example, the nominal system velocity may be 16 m/s. In this example and with a cycle time step of one second, each of the units of the fields are 4 m long. Roads where the speed is desired to be faster than the 16 m/s nominal system velocity may feature units which are longer than 4 m and roads where the speed is desired to be slower may feature units which are shorter than 4 m. The allowed positions for vehicles travelling on certain roads, such as expressways, may be wide enough to accommodate the travel of two side-by-side vehicles.

The positions of fields may be coordinated such that whenever an allowed position occupies a position in an intersection, there is a forbidden position at the fields overlapping with that position at any of the cross roads. By coordinating streams of traffic to be out of phase with one another, vehicles may cross intersections without having to stop or slow down. In some embodiments, vehicles cross intersections at the nominal system velocity. This coordinated relationship can be preserved between different intersections of the interconnected roads by providing an integer number of fields between intersections. In some embodiments, each of the units within intersections are square.

A traffic control system may be provided to facilitate the operation of the centrally controlled transportation system. The control system comprises a number of subsystems that are operative to control specific functions or areas of the interconnected roadways may be delegated. The traffic control system may comprise a central management unit which is operable to route customer requests to controllers responsible for scheduling trips. Local controllers may be provided to control the operation of vehicles in areas defined by certain functional boundaries. Local controllers may comprise expressway controllers, street controllers, and station controllers, for example. Instructions provided by local controllers may include instructions for vehicles to merge, demerge, or to enter a turning lane at particular times and locations according to a schedule.

One aspect of the invention provides a method for scheduling customer trip requests in a centrally controlled traffic system using a “bottom-up” optimization technique. The scheduling method may comprise selecting a vehicle available to serve the customer request for a trip from a starting location to a destination by one or more possible routes. The method may also determine a number of possible departure times (starting times) for the trip. For a given combination of a possible departure time and a possible route, the method queries timetables maintained by local controllers in a series of local controllers responsible for areas traversed by the possible route from an opening station to a closing station to determine whether vehicle travel along the particular route beginning at the departure time can be accommodated. Querying the timetables of each of the local controllers may be done sequentially.

In some embodiments each local controller is provided with a location and time at which the vehicle will arrive at the area controlled by the local controller and the local controller determines a time at which the vehicle can be presented either at the destination or at a location of handoff to a subsequent one of the series of local controllers along the possible route. In some embodiment, each local controller determines a specific route from a location at which the vehicle enters the area for which the local controller is responsible and a location at which the vehicle will leave the area for which the local controller is responsible. In some embodiments each local controller is responsible for selecting a location at which the vehicle will be handed off to the area for which the next local controller in the series of local controllers is responsible.

In some embodiments, all of the cycle time steps within a given time frame, such as a three minute window are selected as possible departure times. The assessment of each possible route may be performed in parallel for plural ones of the possible departure times or all of the possible departure times. In some embodiments, where there are plural possible routes the possible routes are evaluated in parallel. For each possible route different possible departure times may be tried in sequence starting from a “best” possible departure time until departure time is found for which the possible route can be completed to the destination given current traffic in the system.

If at any point a controller in the series of local controllers determines that another vehicle is scheduled to occupy a location required for completing the possible route at the departure time or the route cannot be otherwise satisfied, that particular departure time is eliminated from consideration for that possible route. An optimal departure time and route may then be selected from amongst the departure times and routes for which a trip can be scheduled. Thereafter, each of the local controllers may amend their schedules to include the scheduled vehicle to indicate that the scheduled time/position slots are unavailable for other vehicles to occupy.

One aspect of the invention provides a method of simulating and testing a centrally controlled traffic system. The simulated environment may mirror a planned real-world implementation wherein a planner or engineer can vary different system, layout and other design parameters. Virtual components may interact with each other through a messaging module which mimics information exchanged by the real-world components. Each of the constituent components of the simulated system may be provided in the form of a software module or library allowing for simulated environments to be built with relative ease and modularity. The simulated environment may be operated using the same control software that is used for the real-world implementation, only with simulated data inputs. In some embodiments, the simulated data inputs to the control software originate from a video game environment which allows the testers to experience requesting and taking trips in the virtual environment in simulated vehicles that travel along the same routes that would be travelled in the real-world implementation.

In some embodiments, systems for controlling traffic are distributed control systems that have an architecture such that most data is processed close to where the data originates. Such architectures can significantly reduce data communication requirements. For example, data from sensors that monitor the locations of individual vehicles may be processed by local controllers that are close to the sensors. If necessary, messages containing information derived by processing the sensor data may be sent to other parts of the distributed control system. The messages may be much smaller than the sensor data.

In addition to the exemplary aspects and embodiments described above, further aspects and embodiments will become apparent by reference to the drawings and by study of the following detailed descriptions.

It is emphasized that the invention relates to all combinations of the above features, even if these are recited in different claims.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIGS. 1A to 1D illustrate coordinated streams of vehicle traffic that allow vehicles to pass through level intersections without risk of collision.

FIG. 2 is an illustration of a system of interconnected roadways that includes a number of distinct road types.

FIG. 2A is a schematic view illustrating pedestrian access to a transportation system.

FIG. 3 is an illustration of an example expressway showing specific positions which vehicles may occupy according to a centrally controlled traffic scheme.

FIGS. 4A-4D are illustrations showing an example intersection crossing sequence.

FIG. 5A is a schematic view of an intersection illustrating a number of possible road features. FIG. 5B is a zoomed in view of a portion of FIG. 5A. FIGS. 5C-5D are exemplary schematic views illustrating different options for merging vehicles.

FIG. 6 is a diagrammatic representation of an exemplary traffic control system for providing central traffic control according to an example embodiment.

FIG. 7 is a schematic view of a portion of an interconnected roadway system according to an example embodiment.

FIG. 8 is an illustration of an example road segment illustrating the interaction between a vehicle and a corresponding road controller.

FIG. 9 is a block diagram showing an example method for scheduling customer trip requests.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The technology described herein addresses the basic problem of how to transport people and goods from place to place. The technology is particularly useful in densely populated areas but can be applied anywhere. The technology is described in the context of an integrated smart transportation system that provides point-to-point transportation on demand. However, many inventive aspects of the technology can also be applied in other contexts.

The integrated transportation system provides a fleet of vehicles that travel on a dedicated network of roads. The vehicles are centrally controlled by a master control system. With only a few exceptions the network of roads is used exclusively by the vehicles of the fleet. The roads are separated from pedestrians and separated from vehicles that are not operating under control of the master control system. Such a system may advantageously plan new point to point routes based on knowledge of existing trips scheduled by the system.

Some embodiments permit sections of the network of roads to be designated for special purposes for a period of time. During this period regular vehicle traffic may be routed away from the designated section of the network. Sections of the network may be designated, for example:
to facilitate repairs to the roads in the designated section;
to allow passage of extra large vehicles such as large construction, commercial or military vehicles;
to clear malfunctioning vehicles;
to allow passage of vehicles that are not controlled by a traffic system.

Users may interact with the system to schedule point to point trips. For example a user may reserve a point to point trip using a kiosk, a personal device such as a computer, portable computer, wearable computer or smartphone for example. On receiving the reservation the system may locate a vehicle to carry the user on the reserved trip, control the vehicle to go to a starting point of the reserved trip, and control the vehicle to carry the user to a destination point of the reserved trip. Scheduling and routing trips are discussed in more detail elsewhere herein.

In some embodiments the system of roadways includes level crossings at which two roads intersect. The master control system may control the progress of vehicles along such roads in such a way that the vehicles can continue through any intersection that they reach without stopping. This can be achieved by defining on each road a stream made up of a series of allowed positions that can each be occupied by one of the vehicles. The allowed positions in each stream are spaced apart by forbidden zones that are to be kept free of vehicles. The allowed positions advance with time on each road in a direction of traffic flow so that any or all of the allowed positions can be occupied by vehicles move along each road at a speed maintained by the master control system.

The advancement of the allowed positions on intersecting roads are coordinated so that every time an allowed position on one intersecting street is in the intersection a forbidden zone on the other intersecting street is in the intersection. This guarantees that the intersection will be clear.

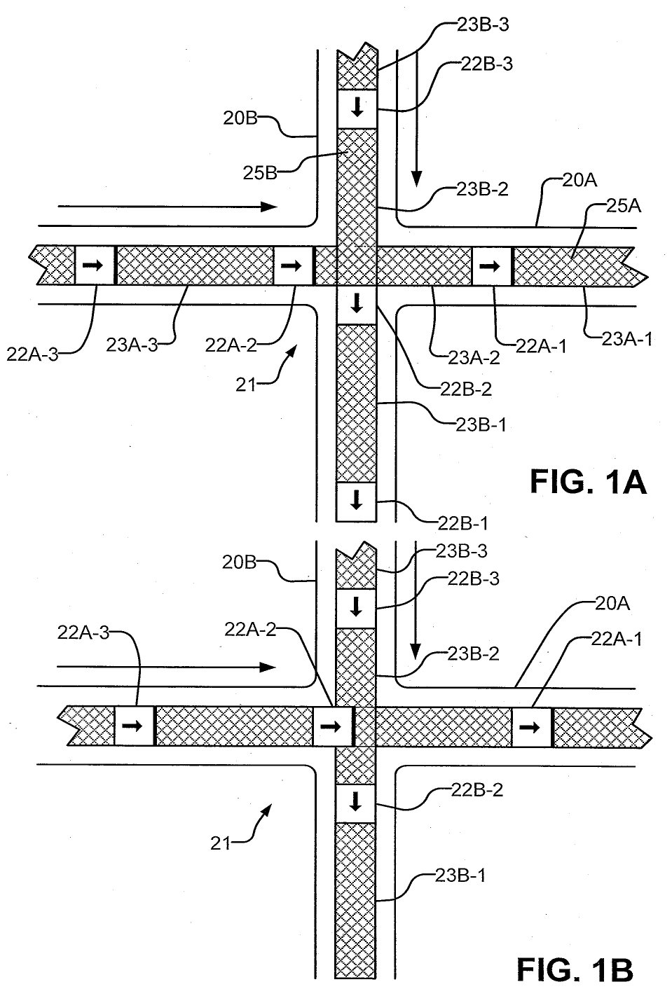

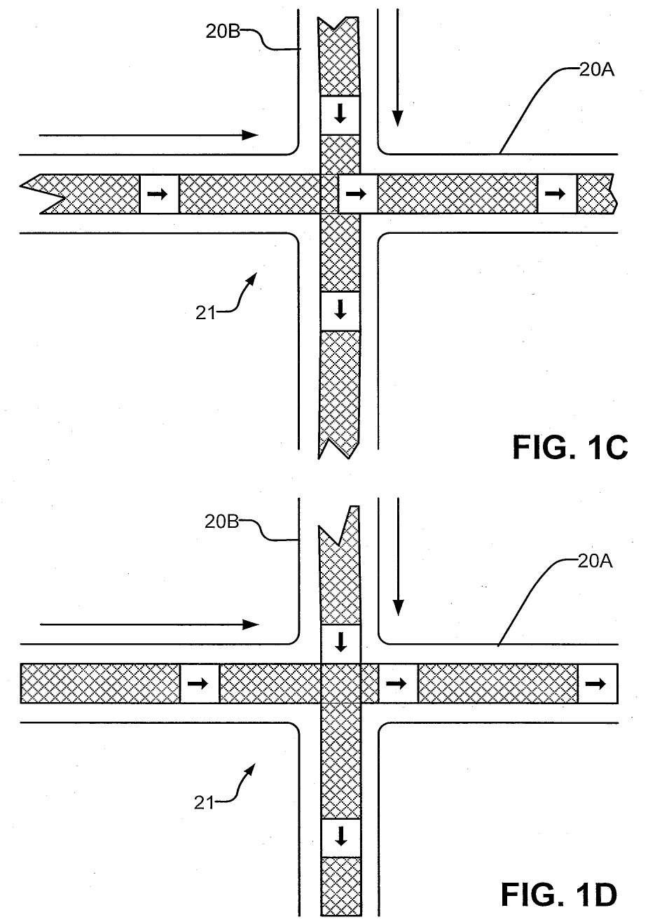

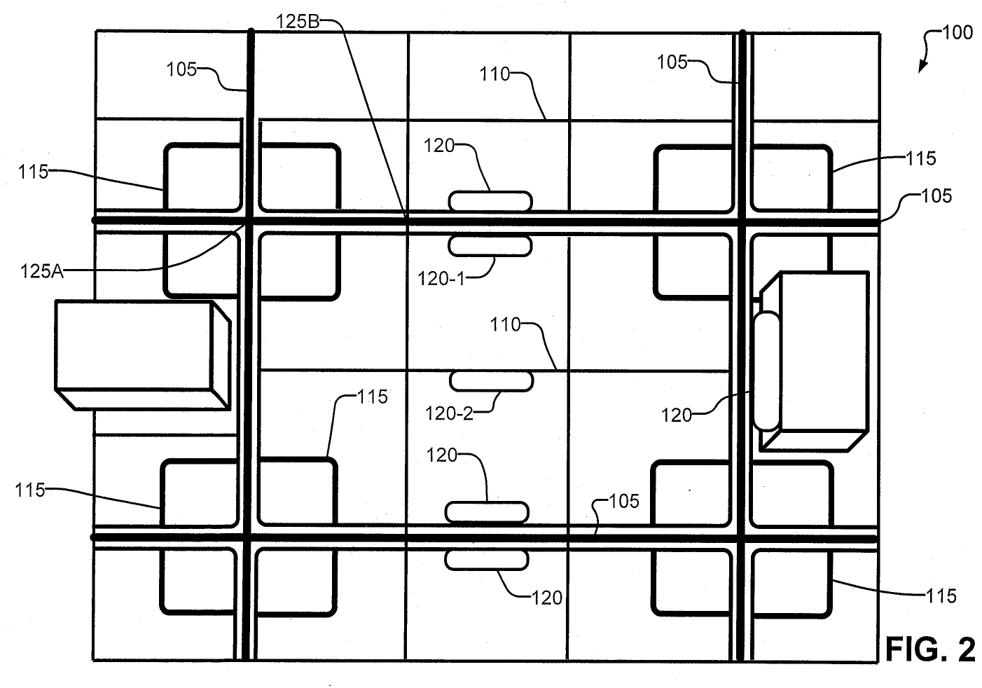

FIGS. 1A, 1B, 1C and 1D are a series of snapshots in time illustrating this principle. One-way roads 20A and 20B cross at an intersection 21. A stream 25A runs on road 20A. Another stream 25B runs on road 20B. Stream 25A includes a series of allowed positions 22A (22A-1, 22A-2 and 22A-3 are shown) which are interleaved with a series of forbidden zones 23A (23A-1, 23A-2 and 23A-3 are shown). Allowed positions 22A and 22B may be referred to generally or collectively as allowed positions 22.

The combination of an allowed position 22 and a following forbidden zone 23 may be called a “field”. Stream 25B includes a series of allowed positions 22B (22B-1, 22B-2, 22B-3 and 22B-4 are shown) which are interleaved with a series of forbidden zones 23B (23B-1, 23B-2 and 23B-3 are shown). Forbidden zones 23A and 23B may be referred to generally or collectively as forbidden zones 23.

In preferred embodiments forbidden zones 23 are longer than allowed positions 22. It is generally preferable that forbidden zones 23 are at least three times as long as allowed positions 22 in the vicinity of an intersection. This automatically provides gaps between vehicles in each stream 25 that are large enough to allow appropriately coordinated cross traffic to continue across the intersection without stopping or slowing and without risk of collision.

For example in currently preferred embodiments each field is made up of an allowed position 22 that is one unit long followed by a forbidden zone 23 that is three units long (for a total field length of 4 units). Each unit may, for example be in the range of 3 to 6 meters (e.g. about 4 meters). In locations away from intersections, there is greater flexibility in the positioning of vehicles, as discussed below.

The progress of streams 25A and 25B is coordinated so that whenever an allowed position 22 on either of roads 20A and 20B reaches intersection 21 there is always a forbidden zone 23 of the stream 25 of the other one of roads 20A and 20B occupying intersection 21.

The principles illustrated in FIGS. 1A to 1D also apply to two-way streets in which each street has one or more streams 25 travelling in each direction. Streams travelling in opposing directions on a road may be coordinated so that, at each intersection that the road crosses, the opposing streams 25 are “in phase” (i.e. forbidden zones 23 in each of the opposing streams reach the intersection at the same time) so that vehicles on a cross street at the intersection can pass through the intersection without stopping.

The relative “phase” of two streams 25 at an intersection is a measure of how closely allowed positions 22 of the two streams come to arriving at the intersection at the same time. Where centers of the allowed positions 22 reach the center of an intersection 21 at the same time the streams 25 can be said to be “in phase”. Where centers of allowed positions 22 in one stream 25 reach the center of intersection 21 at the same time as centers of forbidden zones 23 of the other stream 25 then the two streams 25 are said to be “out of phase”. It is desirable to have crossing streams 25 out of phase at every intersection because this guarantees that there will be no collisions between vehicles travelling with streams 25 in allowed positions 22.

An entire network of intersecting roads can apply coordinated streams 25 so that as long as vehicles are controlled to travel along roads at the allowed positions 22 of streams 25 the vehicles will not need to stop for cross traffic at any intersections.

One way to achieve the desired coordination among streams 25 is for a master controller to control each vehicle that is travelling in the system to remain in and move with an allowed position 22 in a stream 25.

In some embodiments the master controller operates by assigning vehicles to allowed positions 22 in streams 25, controlling vehicles to switch from an allowed position 22 in one stream 25 to an allowed position 22 in another stream 25 (e.g. when merging onto a turning lane to switch to a different street at an intersection or when merging onto a freeway).

In some embodiments the master controller controls each vehicle to advance by one unit (e.g. from one control point to the next control point) in each time step of a master clock. In such cases the choice of length for fields and the way that the units are mapped to streets can facilitate control of the vehicles (and also route planning) by guaranteeing that the positions of allowed positions 22 in streams 25 can remain coordinated such that at every location where a vehicle can switch between streams 25 an allowed position 22 in the vehicle's current stream 25 and an allowed position 22 in the stream into which the vehicle will transfer are juxtaposed to permit the vehicle to make the switch.

Fields may have different lengths. Fields that are 4 units long as described above are advantageous because vehicles that are constrained to be in allowed positions 22 of 4 unit fields can be controlled to pass through intersections of two-way streets without stopping and without risk of collision while allowing a relatively high density of vehicles on the streets.

Field lengths other than 4 units long are possible for coordinating streams of traffic which do not stop for cross traffic at intersections. For example, coordinated traffic streams can be provided in which the number of units forming a field equals four or any even number greater than four.

A system as described herein may maintain a clock which provides system-wide time steps. Each time step may, for example, be a fraction of a second. In some embodiments, the system time step may be, for example, in the range of 0.1 second to 1 second. For example the system time step may be ¼ second, ⅛ second, ⅓ second, ½ second, 3/3 second, ¾ seconds, or 1 second. The travel of vehicles along roads may be synchronized to the system wide time steps.

For example, control points may be spaced apart along each road. Moving from one control point to the next may constitute advancing by one unit or one “distance step”. In a preferred embodiment the control points are spaced apart by a distance that is slightly longer than the length of vehicles of the system. For example, adjacent control points may be spaced apart by about 4 meters and all regular vehicles in the system may have lengths that are less than 4 meters.

The master controller may be configured to control each vehicle to move along the road it is on at a speed such that in each time step the vehicle moves by one distance step —from the location of one control point to the location of the next control point. In some embodiments, at the end of each time step the location of each allowed position 22 has a fixed relationship to the control points (e.g. at the end of each time step the allowed position 22 may be located so that the allowed position 22 occupies the space between two adjacent control points).

The control points may be virtual control points (i.e. control points that correspond to locations specified on a digital map but do not necessarily have any physical presence on the road). In addition or in the alternative, some or all of the control points may comprise one or more of: visible indicia that indicate the location of the control point; a transponder that emits a signal that indicates the location of the control point; a marker that indicates the location of the control point and can be detected by one or more sensors on a vehicle; and/or a sensor configured to detect when a vehicle is at a control point.

As discussed below, control points do not need to be uniformly spaced apart. Control points may be more closely spaced in some parts of a transportation system and spaced farther apart in other parts of the transportation system.

In cases where the control points are defined virtually, it is possible to change the locations of control points (e.g. to change a nominal system velocity, discussed below). For example, the system may switch among different layouts of control points to accommodate different levels of traffic or different characteristics of traffic patterns or on different times of day or different days of the week.

For example, during the evening when there may be fewer vehicles on the road, the nominal system velocity may be increased. This generally involves spacing control points on roads further apart.

During harsh weather conditions, the nominal system velocity may be decreased, which may involve spacing control points on roads closer together. In some embodiments, traffic may be temporarily halted before control point spacing is adjusted. In some embodiments, certain sections of the interconnected roadways are sequentially isolated as spacing adjustments are made.

In some embodiments a system as described herein maintains a digital map that indicates positions of control points across the system. The system may be configured to change the locations of control points from a first arrangement to a second arrangement over a specified period of time, for example, a human operator of the system or an automatic process may trigger a switch between the first and second arrangements of control points. The system may be configured to make the change gradually over a period of time so that vehicles that are moving in the system are transitioned seamlessly from one arrangement of control points to the next.

However, the use of physical control points has certain advantages. For example, providing and using physical control points that can be identified by a controller of a vehicle or a local controller of a transportation system may decrease the amount of data transfer required to operate the system. Thus, the chance for system operation to be adversely affected by communication errors is reduced. Physical control points may be used in conjunction with virtual control points to provide redundancy in verification procedures and to increase overall system safety.

In some embodiments each vehicle has a control system that is configured to keep the vehicle within an allowed position 22 in a stream 25 on a road. The control system may use feedback from sensors in the vehicle or in a local traffic control system to adjust the vehicle's speed to keep the vehicle within the moving allowed position 22 and may adjust the vehicle's direction to follow the road and to maintain an appropriate position side-to-side in the allowed position 22.

For example the vehicle may be instructed to use a certain time step and to move forward by one control point for each time step. The vehicle may include a clock that is synchronized to the master clock. The vehicle may have a local data store that contains locations of control points on the vehicle's path. The vehicle controller may control the vehicle to move the vehicle at a rate such that it will pass each control point in time with the master clock. The vehicle may detect physical control points along the vehicle's path and use these detections as feedback to control the vehicle's speed. If the vehicle control system detects a physical control point too early the vehicle control system may proportionately reduce the vehicle's speed. Where the vehicle control system detects the physical control point too late it may proportionately increase the vehicle's speed.

The vehicle controller may control steering of the vehicle to follow the road that the vehicle is on using a digital map and a geolocation device together with sensors that are operative to monitor road position.

A local controller may periodically check that individual vehicles are where they should be (i.e. occupying an assigned allowed position 22).

Different methods may be employed in different scenarios for indicating the location of control points to vehicles herein based on a number of factors, such as the characteristics of a particular route (e.g. a local terrain of the route), the possibility for signal attenuation, and the like.

The phases of streams 25 may be coordinated by selecting how many control points to include in each part of a road (a block) between two intersections. For example, if the number of control points in every block is a multiple of a number N of control points between one allowed position 22 and the next allowed position 22 (i.e. a multiple of a field length used by the transportation system) in a stream 25 that travels along the block then phase relationships between all streams 25 will automatically be preserved.

As an illustrative example, an allowed position 22 which is one unit long is followed by a forbidden zone 23 which is three units long (for a total field length of 4 units). The phases of streams 25 in this example may be coordinated along different blocks by providing a number of control points between intersections which is a multiple of 4.

The control points may be arranged so that vehicles travelling on ordinary roads 20 through the system travel at relatively consistent speeds in individual portions of roads 20. For example, some embodiments employ the concept of a nominal system velocity. While vehicles on different roads may be controlled to operate at different speeds each of these speeds may bear a fixed relationship to the nominal system velocity. For example:
vehicles on some roads may operate at the nominal system velocity (this is optional);
vehicles on some faster roads may operate at a multiple of the nominal system velocity (e.g. a multiple of 1.5 or 2 or 3);
vehicles on some slower roads may operate at a fraction of the nominal system velocity (e.g. ¾ or ½ or ⅓ or ¼ of the nominal system velocity).
   The nominal system velocity can therefore serve as an overall indicator of the speeds at which vehicles move on roads of a system as described herein. Speeds on all roads in the system may be increased or decreased by increasing or decreasing the nominal system velocity.

Since vehicles are controlled to move between adjacent control points in time with a system clock, there is a relationship between vehicle speed and the spacing between adjacent control points. The speed of vehicles on a section of road may be increased without changing the length of time steps by increasing the distance between adjacent control points (thereby requiring each vehicle to travel farther in each time step. This relationship may be used to cause vehicles to travel faster on certain roads or parts of roads (e.g. on a bridge of an expressway) than in other roads or parts of roads. Control points may be spaced farther apart in those parts of the road network where higher vehicle speeds are desired and closer together in other parts of the road network where slower speeds are desired.

Accordingly, on roads which require a lower average speed or a higher vehicle density, control points may be more dense (more closely spaced) than the control points on roads or portions of roads for which a higher average speed is desired. In some embodiments the nominal system velocity is in the range of about 5 m/s to about 30 m/s (i.e. about 18 to 110 km/h). According to an example embodiment, the nominal system velocity is about 16 m/s (about 58 km/h).

In some embodiments vehicles travelling on any road in the system are controlled to move at a speed such that the vehicle passes from one control point to the next control point in one time step. In the case where control points are 4 meters apart and each time step is ¼ second the corresponding travel speed is 16 m/sec (1 second per field). This is a good speed (35.8 Miles/hour or 57.6 Km/h) for travelling longer distances within a city, for example. Some roads may have a slower speed which may be achieved by spacing the control points closer together. For example, to achieve a speed that is 75% of the nominal system velocity on a portion of a road, the control points on the portion of the road may be placed 75% as far apart (e.g. 3 meters apart instead of 4 m apart). Such roads may, for example, have a vehicle speed of 12 m/s instead of 16 m/s.

Vehicle speed may be made to be differ at different parts of the same road. For example, vehicle speed may be increased over a long stretch of road with no cross roads or when travelling across bridges. This may be done by spacing control points farther apart. For example, doubling the spacing between adjacent control points will double the vehicle speed.

In some embodiments, the nominal system velocity may be adjusted up or down by changing the length of the time steps. Making the time steps shorter will increase all vehicle speeds while making the time steps longer will decrease all vehicle speeds.

In some embodiments the master control system is configured to gradually change the lengths of time steps over a period of time. The gradual change in the length of time steps may represent a change of the nominal system velocity.

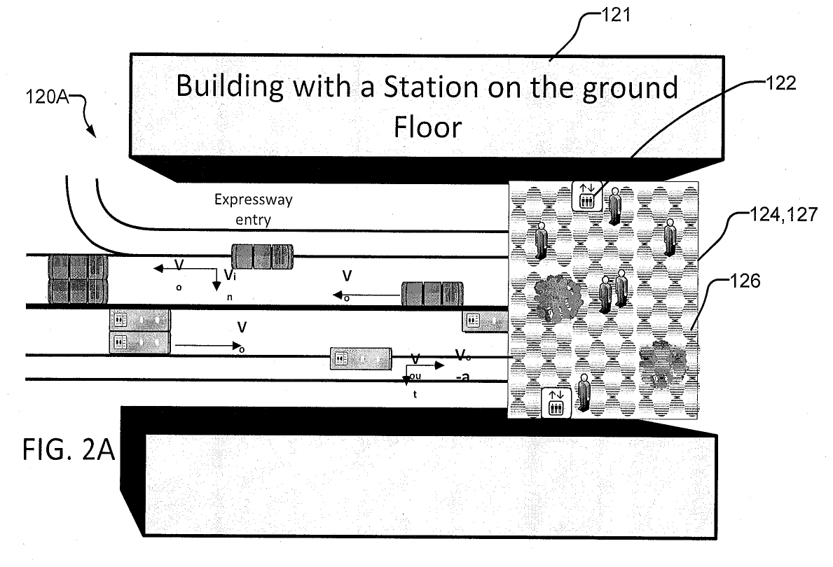

FIG. 2 illustrates an example interconnected roadway system 100 according to an example embodiment of the present invention. Roadway system 100 includes interconnected local roads 110 and expressways 105. The roads of interconnected roadway system 100 are dedicated roads that are separated from regular roadways and vehicles not under central control. Separation may, for example be through grade separation or by delineating non-cooperating city blocks using forms of logical and/or physical separation. By using dedicated roadways on which all vehicles travelling thereon are centrally controlled, a number of optimizations which would be impossible in non-coordinated traffic may be achieved. One example optimization that may be achieved is a higher vehicle throughput by operating vehicles safely at higher average speeds. Accordingly, higher volumes of passenger traffic can be accommodated and trips can be shorter. Furthermore, because of the central control and planning of vehicle routes, travel times may be predicted accurately, potentially resulting in greater customer satisfaction and logistical efficiencies, among other benefits.

Interconnected roadway system 100 may comprise roads of a number of different types. Roads of different types may have different physical characteristics and/or a master controller may control vehicles operating on roads of different types with differing operating parameters.

Expressways 105 are limited-access roads intended for higher-speed traffic. Local roads 110 are roads intended for local traffic to access passenger stations 120 that are located for convenient access to passenger destinations such as businesses, housing, etc. A typical point to point trip may originate at a station 120, travel by one or more local roads 110 to an expressway 105, travel along the expressway 105 to another local road 110 and end at a destination station 120.

A system as described herein may include a large number of stations 120. Stations 120 may, for example, be provided in the basements or lower floors of buildings, in shopping malls, at office towers and other places of employment, at art galleries and museums, at public plazas, near sports complexes, in residential neighbourhoods, at private homes, etc. There may be enough stations 120 distributed widely enough that for many people who use the system stations 120 can be found within a short distance of their homes, their workplaces and other places that they tend to go in their daily lives.

FIG. 2A is a schematic view of an area of a city in which a station 120A is located in a lower floor of a building 121. Station 120A may be accessed from within building 121 or by elevators 122 from a raised public plaza 124. Some or all of local roads 110 and expressways 105 may be covered by elevated pedestrian walkways 127. The pedestrian walkways may comprise solar panels 126 that harvest solar energy. Solar panels 126 may, for example be integrated with tiles or pavement that provide a walking surface of pedestrian walkways 127. The solar energy may provide electrical power for operation of vehicles on a roadway system 100 and/or for other purposes.

In some embodiments, vehicles travel on expressways 105 at higher speeds than on local roads 110. For example, on expressways 105 the vehicles may travel at the nominal system velocity. In some embodiments, vehicles travelling on local roads 110 move at a set percentage of the nominal system velocity (except in particular circumstances). Vehicles moving in stations 120 may be operated at a further reduced percentage of the nominal system velocity. By way of non-limiting example, vehicles on expressways may travel at the nominal system velocity, vehicles on local roads may travel at 75% of the nominal system velocity and vehicles travelling in stations may travel at 50% of the nominal system velocity.

According to a preferred embodiment, vehicles travelling on roads of roadway system 100 are controlled using the methods and systems described herein to occupy moving allowed positions 22 on the roads. Each vehicle is separated from adjacent allowed positions 22 in front and behind the vehicle by forbidden zones 23. Vehicle movements on the dedicated roadways of roadway system 100 can be wholly orchestrated according to the centrally controlled traffic scheme.

Turning loops 115 may be provided to eliminate the need for vehicles to make turns across any oncoming traffic lanes at intersections 125. For example, where vehicles drive on the right hand side of two-way roads, turning loops 115 may be used to eliminate the need for left hand turns at any intersections 125. For example, a vehicle can be controlled to turn right at a turning loop 115 after an intersection and to turn right again at the intersection of the turning loop with the cross street from the intersection, thereby arriving on the cross street travelling in the same direction as if the vehicle had made a left turn at the intersection.

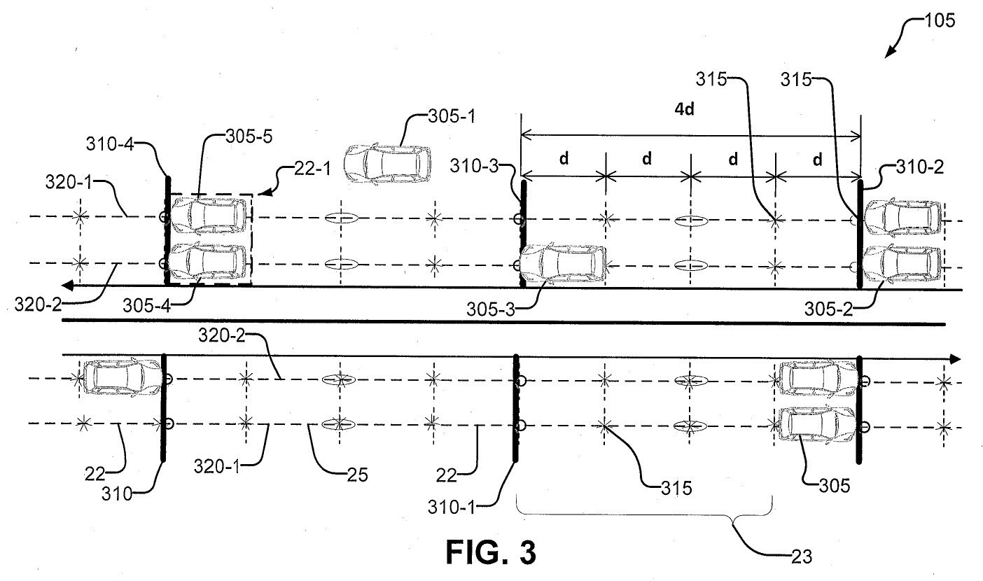

FIG. 3 illustrates an example road (in this case an expressway 105) showing the application of the above principles wherein vehicles occupy specific allowed positions 22. In FIG. 3, a number of vehicles 305 are shown to be travelling in each direction on expressway 105. Control points 315 are spaced apart along expressway 105. Allowed positions 22 are defined with respect to control points 315.

In FIG. 3, each allowed position 22 is indicated by a corresponding locking point 310. In this example, every fourth control point 315 is identified as a locking point 310. In FIG. 3, adjacent control points 315 are separated by a distance d. Adjacent locking points 310 are shown as being separated by four control points 315, or at a distance of 4 d (see e.g. locking points 310-2 and 310-3). Although the separation of adjacent locking points 310 by four control points 315 is not mandatory, such a configuration provides certain advantages in coordinating traffic between intersecting roads.

With each time step each locking point 310 is moved by one control point 315 in the direction of travel and each vehicle 305 is controlled to move along the road to the next control point. Every vehicle 305 travelling along expressway 105 occupies a position 22 that is dictated by the location of a corresponding locking point 310 to which the vehicle has been assigned. Accordingly, a vehicle 305 assigned to or “locked” to a particular locking point 310 will move to the following control point 315 with the vehicle's corresponding locking point 310.

It is not necessary that vehicles 305 are positioned at every locking point 310, as shown by locking point 310-1 where no vehicles 305 are positioned.

As shown by vehicle 305-1 and described later herein, there are circumstances where vehicles 305 may deviate from the set locking points 310, such as for merging/demerging from expressway 105 and for making turns.

According to an illustrative example and with reference to FIG. 3, the system time step is configured to be ¼ seconds and the nominal system velocity is configured to be 16 m/s. In this example, locking points 310 move 4 meters to the subsequent control point 315 with every time step, or every ¼ seconds. Each locking point 310 will accordingly move a distance of 4 d, or 16 meters, every 1 second. Accordingly, after the passage of 1 second in this example, every locking point 310 will have moved to the position previously occupied by a successive locking point 310 one second earlier. According to this example, after the passage of 1 second, vehicle 305-2 will have moved to the position currently occupied by vehicle 305-3, and vehicle 305-3 will have moved to the position currently occupied by vehicle 305-4.

Some embodiments of the present invention employ the concept of a “cycle time step”. The cycle time step represents the duration of time which passes for allowed positions 22 to occupy the same positions presently occupied by subsequent allowed positions 22. In other words, the concept of a system time step can thus be defined as t_{c}/n, where t_{c} is the cycle time step and n is the number of units in each field, or “cycle”. In the illustrative example where the system time step is configured to be ¼ seconds and each field comprises 4 units, the cycle time step is 1 second. This concept is illustrated with reference to FIG. 3 wherein locking points 310 occupy the position of a successive locking point 310 after the passage of the cycle time step, or 1 second.

In some embodiments, two or more vehicles may be aggregated to travel together in the same allowed position 22. For example, two vehicles may be aggregated to travel together side-by-side. In some embodiments, a lane or axis is defined for each of the aggregated vehicles within position 22 according to which that vehicle's travel is constrained. As another example, two parallel front vehicles are separated from two parallel rear vehicles by a certain distance, all four vehicles travelling at a uniform speed and direction for at least a certain length of time. By aggregating vehicles, various optimizations to the overall functioning of the integrated transportation system herein may be obtained. For example, spaces separating adjacent vehicles may be significantly diminished, which allows for increased vehicle throughput of the transportation system. Since the vehicles are automatically controlled the spacing between vehicles travelling in the same allowed position 22 may be far less than would be safe for human drivers.

As illustrated in FIG. 3, vehicles 305-4 and 305-5 are shown to form an aggregated pair where they occupy a single allowed position 22-1. Accordingly, vehicles 305-4 and 305-5 travel in unison with locking point 310-4 to the subsequent control point 315 with every passing time step.

Expressway 105 in the FIG. 3 example comprises separate outer lanes 320-1 and inner lanes 320-2 (collectively, lanes 320) in both directions of travel. Each lane 320 provides a path along which a corresponding stream 25 may direct vehicles 305. Adherence of vehicles 305 to their defined lanes 320 can be maintained, for example, by the monitoring and verification techniques discussed below.

Parallel lanes 320 (e.g. lanes 320-1 and 320-2) may be separated by a space such that there is sufficient spacing to safely accommodate two standard-sized vehicles 305 positioned around a central axis of lanes 320 (the center of lanes 320 is indicated by dashed lines in FIG. 3).

In some embodiments, vehicles (e.g. vehicle 305) employed in the transportation system of the present invention are dimensioned to fit within an envelope having a standard length and width. In some embodiments vehicles 305 all have standard length and width dimensions. In some embodiments vehicles 305 are the same as one another. The use of standard vehicle dimensions advantageously allows for pre-programmed traffic routines to be performed safely and predictably, while optimizing the amount of space available for the transportation of persons and/or goods. Standard passenger vehicles 305 may, for example have lengths in the range of 2-6 m and widths in the range of 1-3 m. According to a more specific example embodiment, passenger vehicles have a length of around 3.7 m and a width of around 1.7 m.

In some embodiments, allowed positions 22 comprise areas dimensioned to accommodate one or more vehicles 305 (see for example allowed positions 22 in FIGS. 1A-1B). In some embodiments the areas corresponding to allowed positions 22 are generally square (e.g. have a width to length ratio of about 1:1).

As discussed below, having allowed positions 22 which are generally square (and forbidden zones 23 which are generally rectangular with an integer ratio of length to width) advantageously facilitates certain intersection control sequences. Positions 22 and 23 may be defined by different ones of the static control points 315 at different time steps to reflect the system-determined locations of allowable vehicle positions at that particular time. As shown in FIG. 3, vehicles 305-4 and 305-5 occupy a square shaped allowed position 22-1, indicated by dashed lines. According to an illustrative example, the square allowed position 22-1 has dimensions of around 4×4 m. Vehicles 305-4 and 305-5 may each have example dimensions of 3.7×1.7 m and may therefore be able to fit parallel to each other within allowed position 22-1 while being separated by a small space.

In some embodiments, an allowed position 22 may also accommodate a single, wide vehicle (e.g. a vehicle up to about 3.6 m wide), Routes which are selected for the travel of wide vehicles should contain roads (e.g. local roads, turning lanes, etc.) which are wide enough to accommodate such vehicles. In some embodiments, certain roads and routes are specifically designated for accommodating the travel of wide vehicles.

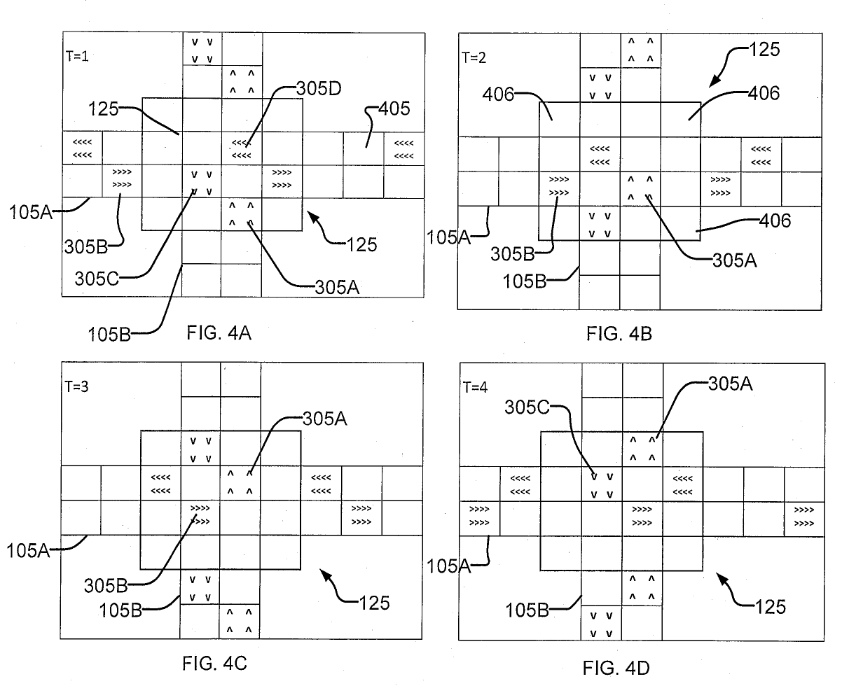

The concept of restricting vehicle locations to allowed positions 22 of coordinated streams 25 offers a number of advantages. Some embodiments of the present invention provide systems for non-stop traffic at intersections, wherein vehicles travelling through intersections do not have to slow down or stop while avoiding any possibility of collision. FIGS. 4A-4D schematically illustrate an example sequence in which vehicles 305 travel across a four-way intersection 125 without slowing down or stopping. A plurality of cells 405 arranged as a grid is shown, wherein each cell 405 represents an area that may be occupied by one or two vehicles 305 during those time steps in which the cell 405 corresponds to an allowed position 22. The grid may, for example, be defined by control points 315 (not shown in FIGS. 4A-4D).

FIGS. 4A-4D employ the configuration illustrated by FIG. 3. That is, adjacent allowed positions 22 are spaced apart by forbidden zones 23 that occupy three cells 405. In this example each road has two streams going in each direction. Up to two vehicles can travel side by side. Allowed positions 22 and forbidden zones 23 advance to a subsequent cell 405 with each time step.

As illustrated, cells 405 are represented by squares, and thus, allowed positions 22 and forbidden zones 23 have a square shape. The use of cells 405 which are square facilitates the intersection sequence illustrated in FIGS. 4A-4D because vehicles 305 travelling in orthogonal directions are able to occupy the same cells within intersection 125 at different times without projecting past boundaries of the cells. Providing forbidden zones 23 which occupy three generally square cells (for a field length of four cells) allows cross traffic to proceed through the intersection without collisions and without stopping while providing high throughput through the intersection 125 in both directions.

FIGS. 4A-4D illustrate the configuration of vehicles 305 at intersection 125 at successive time steps, with FIG. 4A showing the configuration at a first time step and FIG. 4D showing the configuration at a fourth time step. Intersection 125 is formed by intersecting expressways 105A and 105B. Each of vehicles 305A, 305B, 305C, and 305D (collectively, vehicles 305) are travelling in different directions. Each vehicle is indicated by arrows, the direction of the arrows indicating a direction of travel of the vehicle 305.

Although vehicles 305 may be referred to in the singular in the discussion of the FIGS. 4A-4D examples, it will be appreciated that such singular reference can refer to both a single vehicle 305 or to a pair of vehicles 305 occupying a single cell 405, as described in the FIG. 3 example.

As an illustrative example, beginning with FIG. 4A at the first time step, indicated as T=1, vehicle 305A is in a position just before entering intersection 125. In the following time step T=2 in FIG. 4B, vehicle 305A is shown to have just entered intersection 125. Subsequently at T=3 in FIG. 4C, vehicle 305A has moved to a position where it is about to leave intersection 125. Finally, at T=4 in FIG. 4D, vehicle 305A has exited intersection 125.

It will be apparent that the next allowed position 22 after vehicle 305A (and the next allowed positions after all other vehicles in the FIG. 4 example) will be in the configuration shown in FIG. 4A at the successive time step (T=5). Thus, in the illustrative example where the system time step is configured to be ¼ seconds, the sequence illustrated in FIGS. 4A-4D repeats every 1 second. The cycle time step in this example is accordingly 1 second.

The positions of locking points 310 and therefore, possible locations for vehicles 305, are configured such that other vehicles cannot occupy a space (represented by cells 405) within intersection 125 that is currently occupied by another vehicle 305 crossing intersection 125, thus eliminating the possibility for collisions at intersections.

The positions of allowed positions 22 in the different streams crossing intersection 125 are coordinated such that any of cells 405 in the intersection can correspond to an allowed position for a vehicle 305 travelling along one of expressways 105A and 105B in one time step and can correspond to an allowed position for a vehicle 305 travelling on the other one of expressways 105B, 105A in a subsequent time step. For example, at the first time step T=1 in FIG. 4A, vehicle 305D has just entered intersection 125. At T=2 in FIG. 4B, vehicle 305A, travelling in a direction orthogonal to vehicle 305D's direction of travel, occupies the same relative position wherein vehicle 305A has just entered intersection 125. At T=3 and T=4 in FIGS. 4C and 4D, vehicles 305B and 305C respectively occupy cells 405 wherein the vehicles, in their respective directions of travel, have just entered intersection 125. As shown, a consequence of the illustrated intersection scheme is that one pair of vehicles 305 travelling in orthogonal directions are allowed to occupy opposite corners of intersection 125 at any given time frame (see vehicles 305C and 305D in FIG. 4A, for example).

As shown in FIG. 3 and in FIGS. 4A-4D, the spacing of locking points 310 and vehicles 305 at a distance of four control points 315 (or at every four cells 405) permits the illustrated intersection sequence to be reproduced indefinitely. In doing so, the above objective of non-overlapping vehicle positions at intersections can be accomplished, allowing for vehicles to approach, travel through, and exit intersections at a constant speed without slowing or stopping and without risk of collisions.

Although a four-way intersection is illustrated wherein the roads accommodate the travel of a pair of adjacent vehicles, a wide variety of variations are possible which respect the key principle of controlling the allowable positions which vehicles may occupy on intersecting roads. The described intersection sequence is most effectively employed on intersecting roads which are orthogonal. However, appropriate modifications can be made to accommodate non-orthogonal intersections and different intersection types, such as three-way or five-way intersections. Such modifications include varying one or more of particular vehicles' speeds, the number of time steps needed to complete a single iteration of the intersection sequence, and the spacing of adjacent locking points.

In some embodiments, one or more roundabouts are provided. Similar to other roads described herein, the roundabouts can carry streams 25 that comprise a plurality of allowed positions 22 such that a central traffic controller can assign vehicles 305 to those allowed positions 22 at particular times. Similar to the example intersection sequence of FIG. 4, roundabouts may be used in a centrally controlled traffic scheme to allow continuous movement through intersections. The use of roundabouts may be desirable in scenarios where traffic lanes exiting the intersection are not orthogonal, for example. Roundabouts may also be desirable for facilitating left turns and/or U-turns. In some embodiments, a combination of orthogonal intersections (such as intersection 125) and roundabouts are employed in the same transportation system.

It will be appreciated that in the sequence illustrated in FIGS. 4A and 4D all vehicles travelling through intersection 125 move at a uniform speed, as the cells 405 representing allowable positions for vehicles at a given time step are equally dimensioned for all directions of travel. In preferred embodiments, vehicles 305 approach, travel through, and exit intersections 125 at the nominal system velocity. In some embodiments, all vehicles 305 travelling along interconnected roadway system 100 adjust their speeds to match the nominal system velocity when approaching any intersections 125.

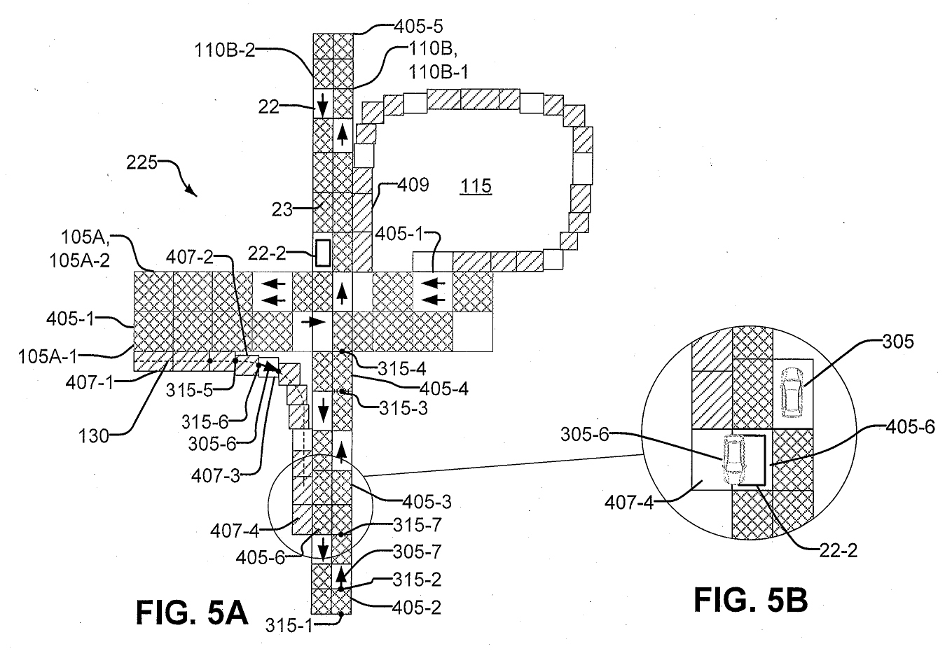

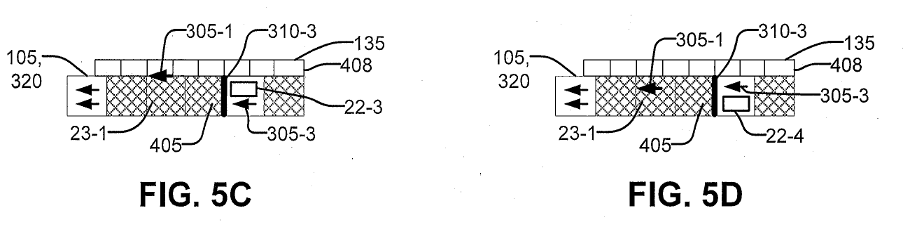

FIG. 5A shows an example intersection 225 that illustrating the principle wherein vehicles 305 travel across intersections at a uniform speed (such as the nominal system velocity). FIG. 5A shows a number of vehicles 305 travelling on expressway 105A and local road 110B, in the vicinity of intersection 225.

As discussed, vehicles travelling on local roads 110 may be configured to move at a set percentage of the nominal system velocity. This may be achieved, for example, by reducing the spacing of control points on the local roads. A plurality of cells 405-1 are shown, cells 405-1 representing an area that a group of vehicles 305 may occupy on expressway 105A. As illustrated, a pair of aggregated vehicles 305 may occupy a single cell 405-1, although other variations are possible as discussed above. Cells 405-1 on expressway 105A are shown to have uniform dimension. As such, vehicles 305 on expressway 105A move at a constant velocity as they approach and travel through intersection 225.

In contrast, vehicles 305 travelling on local road 110B are shown to be travelling on cells 405 which are defined by pairs of control points 315 which are spaced apart at different distances. In the illustrated embodiment, the cells 405 of local road 110B are configured such that vehicles 305 travelling thereon accelerate to the same speed of vehicles 305 travelling on expressway 105A when crossing intersection 225. Following the intersection crossing, vehicles 305 travelling on local roads 110B decelerate, e.g. to resume their prior speed.

For example, control points 315-1 and 315-2 defining cell 405-2 of local road 110B are spaced apart by a smaller distance compared to control points 315-3 and 315-4 defining cell 405-4. Thus, a vehicle 305 travelling at an allowed position 22 located at cell 405-2 is slower than a vehicle located at cell 405-4. This increase in speed is to allow for all vehicles 305 to travel across intersection 225 at a uniform velocity and to perform the intersection crossing sequence illustrated in FIGS. 4A-4D. As illustrated, cell 405-4 has a length that is substantially the same as cell 405-1 (on expressway 105A) in the direction of travel. It will be appreciated that the illustrated equalization of velocity is merely an example. In some embodiments, speeds are equalized earlier than that illustrated to allow for more gradual changes to occur.

Preferably, the increase in speed for a vehicle 305 travelling on local road 110B and approaching intersection 225 is gradual. As illustrated, vehicles 305 at cell 405-3 move at a speed which is faster than vehicles 305 travelling in cell 405-2 but which is slower than vehicles 305 travelling in cell 405-4. The opposite of the above principles may be applied to vehicles 305 leaving intersection 225.

For example, vehicles 305 which have completed the illustrated intersection sequence and which are at cell 405-5 have returned to the original speed configured for local roads 110B. For example, the speed of vehicles 305 at cells 405-2 and 405-5 may be about the same. The rate at which vehicles 305 accelerate and decelerate when approaching and leaving intersections (based on the defined spacing of control points 315) may depend on a number of factors. Such factors may include operating vehicles at parameters which maximize energy efficiency and/or passenger comfort, as well as the capabilities of vehicles 305.

Local road 110B accommodates a single stream of vehicles 305 travelling in opposite directions in first and second lanes 110B-1 and 110B-2 (also referred to herein as local roads 110B-1 and 110B-2). Furthermore, cells 405 of local road 110B away from the vicinity of intersection 225 (e.g. cells 405-2 and 405-5) have approximately half the length compared to cells 405-1 of expressway 105A. Accordingly, vehicles travelling on local roads 110B are accelerated as they approach intersection 225 to match the speed of vehicles travelling on expressway 105A. In other embodiments, vehicles 305 travelling on both local roads 110B and expressway 105A travel at the same speed. In other embodiments, vehicles 305 traveling on expressway 105A are decelerated when approaching intersections to match the speed of vehicles 315 travelling on local roads 110B.

The road configuration illustrated in FIG. 5A further comprises features which permit vehicles 305 to perform right turns at intersection 225 without disturbing the continuous flow of traffic across the intersection. As shown, expressway lane 105A-1 accommodates the travel of vehicles 305 towards the right. A number of right turn cells 407 representing allowable positions in right turn lane 130 are shown adjacent expressway lane 105A-1 and before intersection 225. Right turn lane 130 permits vehicles 305 travelling on expressway lane 105A-1 to turn right at intersection 225 and to subsequently travel on local road 110B-2.

Vehicle 305-6 in FIG. 5A demonstrates an example sequence of steps that a vehicle 305 may perform to complete a right turn. In some embodiments, the cells 407 of right turn lane 130 are configured such that vehicles 305 performing right turns can re-integrate and merge with existing traffic following the turn without stopping, as discussed below.

As an initial step, vehicle 305-6, which has been instructed to turn right, demerges from expressway lane 105A-1 and enters cell 407-1 of right turn lane 130. This step is completed at a time step prior to that illustrated in FIG. 5A. At a subsequent time step, vehicle 305-6 alters its trajectory to travel in a curved path following right turn lane 130. In some embodiments, instructions for a vehicle 305 to alter its trajectory are provided by the direction of a line segment connecting adjacent control points 315. As illustrated, the combination of control points 315-5 and 315-6 defines a cell 407-2 and a line segment with a direction slightly below horizontal. A vehicle 305 travelling in cell 407-2 may accordingly be instructed to begin turning right (from the perspective of vehicle 305).

Next, as shown in FIG. 5A, vehicle 305-6 is positioned at cell 407-3. Vehicle 305-6 is configured to continue travelling in a direction and trajectory defined by right turn lane 130.

At subsequent time steps during the illustrated right turn sequence, vehicle 305-6 travels along cells 407 which become generally parallel with local road 110B-2. The cells 407 also gradually become the same length as the cells 405 of road 110B-2. As shown, cell 407-4 has the same length as that of cell 405-6, meaning that a vehicle 305 at cell 407-4 has equalized its speed with that of local road 110B-2.

In some embodiments, when a vehicle 305 performing the illustrated right turn sequence has equalized its speed with that of the target road it is guaranteed that a cell corresponding to an allowed position 22 will be immediately beside the vehicle 305 in a stream 25 of the target road. Route planning can ensure that the allowed position 22 has room to accommodate the vehicle 305. The vehicle 305 can therefore merge onto the target road and join a stream 25 on the target road. FIG. 5A shows that a vehicle 305 may merge from cell 407-4 of right turn lane 130 into cell 405-6 of local road 110B-2. The process of merging may occur over one time step or over several time steps (where vehicle 305 may occupy parts of cells 405 and 407 simultaneously during these time steps).

In the example embodiment illustrated in FIG. 5A, cells 407 of right turn lane 130 are configured to permit vehicles 305 to turn right and then merge onto local road 110B-2 without stopping. This principle is illustrated in FIG. 5B, which is a magnified view of vehicle 305-6 and cells 405 and 407 in the area encircled in FIG. 5A after the passage of seven time steps.

Referring to FIG. 5B, an empty allowed position 22-2 at cell 405-6 is adjacent cell 407-4. Vehicle 305-6 is shown to be in the process of merging from right turn lane 130 into local road 110B and simultaneously occupies parts of both cells 407-4 and 405-6. Accordingly the illustrated process allows vehicle 305-6 to enter the empty allowed position 22-2 without having to stop during the process of turning. In the illustrated FIG. 5A example, an appropriate number of cells 407 are provided in right turn lane 130 such that continuous right turn sequences are possible. It will be appreciated that different configurations of right turn lane 130 and cells 407 are possible in other embodiments for achieving continuous right turns.

In some embodiments, a centralized traffic controller has knowledge that vehicle 305-6 is scheduled to make a right turn at intersection 225 at the particular time step. Accordingly, the centralized traffic controller may control the scheduling of other vehicles 305 such that allowed position 22-2 in the vicinity of intersection 225 is unoccupied for allowing vehicle 305-6 to subsequently occupy the allowed position 22-2.

In the illustrated embodiment, local road 110B accommodates a single stream of vehicles 305 travelling in each direction. However, in other embodiments, both lanes 110B-1 and 110B-2 may be provided to accommodate multiple streams of vehicles 305.

Other examples of intersecting roads which accommodate the travel of multiple streams of vehicles 305 in each direction at an intersection of cross roads are described (such as in FIGS. 4A-4D). In such embodiments, an allowed position 22 may be assigned to vehicles 305 performing the described right turn sequence even where another vehicle occupies that allowed position (such as allowed position 22-2) such that the right turn can be completed without vehicles 305 stopping. The vehicle already occupying the allowed position 22 may be moved to a stream 25 in an inner lane and/or may be positioned within the allowed position 22 to allow the incoming vehicle 305 to aggregate with the other vehicle, thereby allowing the incoming vehicle to merge into the allowed position 22 and complete the right turn sequence.

As shown, the length of cell 407-2 is shorter than that of cell 407-1, which reflects the fact that turning vehicles often slow down to facilitate passenger comfort and to maintain vehicle traction. However, the decrease in speed is not necessary for performing right turns in the present invention. In some embodiments, right turn lanes 130 are provided which comprise cells 407 having uniform lengths such that vehicles 305 travelling thereon maintain a constant speed while turning. Such embodiments may be appropriate where right turn lane 130 has a relatively large radius of curvature, for example.

Only a single right turn lane 130 is illustrated in FIG. 5A for the purpose of simplicity. However, it will be apparent that additional right turn lanes 130 (and corresponding cells 407) could be provided and be appropriately configured to allow vehicles 305 to perform right turns at other parts of intersection 225. For example, right turn lanes 130 could be provided to allow vehicles 305 travelling on local road 110B-2 to turn right onto expressway lane 105A-2, for vehicles 305 travelling on local road 110B-1 to turn right onto expressway lane 105A-1, etc. In some embodiments, right turn lanes 130 are provided at locations away from intersections, for example, on one-way roads.

There are a large number of possible variations of the embodiments described above may be appropriate for accomplishing the goal of performing right turns which do not disturb the flow of continuous traffic at intersections and which permit merging onto a target road. In the FIG. 5A embodiment, vehicle 305-6 accelerates to and reaches the regular speed of vehicles 305 travelling on local road 110B at the time of merging.

In other embodiments, vehicles 305 which are instructed to merge occupy a position ahead of an assigned allowed position at a lower speed than that of vehicles travelling on the target road at the time of merging. Subsequently, the merging vehicle 305 may gradually accelerate to the speed of the target road, at which point the vehicle 305 occupies the assigned allowed position. In other embodiments, a merging vehicle 305 begins merging onto a target road at a speed which is higher than that of the road and at a position behind the assigned allowed position. Thereafter, the merging vehicle 305 decelerates for a period of time to eventually occupy the assigned allowed position.

FIG. 5C schematically illustrates an example implementation where a merging vehicle 305-1 is ahead of an assigned allowed position 22-3. Vehicle 305-3 is located adjacent position 22-3 on an inner lane and it is intended that vehicles 305-1 and 305-3 form a pair of aggregated vehicles which travel together following the merging procedure. This scenario is also shown in the FIG. 3 example. As shown in FIG. 5C, vehicle 305-1 is instructed to merge onto lane 320 of expressway 105 and to eventually occupy an assigned allowed position 22-3. Prior to merging, vehicle 305-1 travels on one-way road 135.

A number of cells 408 are shown which represent the possible positions on street 135 that a vehicle 305 may occupy at a given time step. As illustrated, the length of cells 408 are uniform and are shorter than those of cells 405. Accordingly, vehicle 305-1 entering expressway 105 moves at a slower speed compared to other vehicles travelling on expressway 105.

FIG. 5C shows that vehicle 305-1 begins merging onto expressway 105 at forbidden zone 23-1. Although forbidden zones are generally to be kept free of vehicles, certain exceptions may be made to facilitate merging/demerging procedures at locations away from intersections, such as in the present example. Upon entering expressway 105, vehicle 305-1 is travelling at a slower speed than vehicle 305-3, dictated by its previous travel along the comparatively shorter cells 408.

Once vehicle 305-1 has merged onto expressway 305 at zone 23-1, vehicle 305-1 should not follow the speed dictated by cells 405 as vehicle 305-1 is currently moving at a slower speed and is ahead of its assigned position 22-3. Rather, in some embodiments, an on-board controller of vehicle 305-1 executes a software routine which takes into account the merging vehicle's current speed, the speed of the target road, and the distance from the assigned position 22-3. Execution of the software routine by the on-board controller may cause vehicle 305-1 to accelerate to the speed dictated by the control points defining cell 405 and to occupy position 22-3 after a period of time. Vehicle 305-1 may eventually occupy position 22-3 after any number of time steps, which may be one to ten time steps, for example.

As illustrated, vehicle 305-1 enters expressway 105 at a cell 405 which is two cells ahead of the assigned position 22-3. In other embodiments, vehicle 305-1 enters at a cell 405 that is one or three cells ahead of assigned position 22-3. It will be apparent to one skilled in the art that the reverse of the above principles are applicable to a merging scenario where vehicle 305-1 enters expressway 105 behind assigned position 22-3 and where vehicle 305-1 is initially faster than the speed configured for vehicles on the target road. In such embodiments, one-way street 135 may comprise cells 408 which are wider than cells 405 of expressway 105.

It will be appreciated that the above merging procedures are not restricted to scenarios involving merging onto a target road following a turn at an intersection. In some embodiments, the above merging procedures are applicable to vehicles leaving the passenger stations 120 and merging onto a local road 110 or an expressway 105.

A procedure by which vehicles demerge from a stream on one road to travel on another road may share many of the principles described above in relation to merging. In many respects, a vehicle demerging can be thought of as merging onto another target road. In some embodiments, a vehicle 305 which is instructed to demerge from a road moves away from the original road while initially maintaining its speed. This is shown in FIG. 5A where, at a previous time step, vehicle 305-6 demerges from cell 405-1 to cell 407-1 while initially maintaining its speed. In other embodiments, a vehicle 305 which is instructed to demerge can be initially positioned in front of the target cell or be positioned behind the target cell following the demerging.

It will be appreciated that different embodiments may employ any of a large number of possible variations to the described merging/demerging procedure are appropriate. For example, according to another example embodiment, vehicle 305-1 travelling on one-way road 135 moves at the same velocity as vehicles travelling on expressway 105 at the time of merging. Vehicle 305-1 may then decelerate until it occupies allowed position 22-3, at which point a local controller controls vehicle 305-1 to move at the speed of other vehicles travelling on expressway 105. Conversely, a vehicle demerging may accelerate to a position forward of allowed position 22-3, demerge, and then subsequently travel according to the control point pattern of one-way road 135.

There are a number of advantages in executing merging/demerging procedures where the merging/demerging vehicle occupies an intermediate point between allowed positions 22 for at least a portion of the procedure. In the case of an example expressway 105 where vehicles 305 can travel in pairs, the vehicle 305 not involved in merging/demerging is permitted to occupy an outer lane or an outer position in an allowed position 22.

With reference to FIG. 5D, vehicle 305-1 is instructed to merge onto expressway 105 in an assigned allowed position 22-4 located on an inner lane. As illustrated, vehicle 305-1 will briefly pass in front of existing vehicle 305-3 at an intermediate location (shown as forbidden zone 23-1) before completing the merging procedure as described above.

Merging/demerging procedures which involve entry and exit to an adjacent road without first occupying an intermediate position (such as that shown in FIG. 5B) requires the merging/demerging vehicle to occupy the outer lane. By allowing the non-merging vehicle(s) to occupy any lane or stream on the road, more merging/demerging opportunities are provided. This accordingly allows greater freedom in assigning vehicles to different allowed positions, thus allowing for a higher vehicle throughput to be possible. Furthermore, there is a reduced computational complexity in the central assignment of vehicles to allowed positions, as the coordination required to assign merging/demerging vehicles to an outer lane (and the corresponding vehicle(s) in the pair to inner lanes) is eliminated.

Returning to FIG. 5A, intersection 225 illustrates an example turning loop 115. As discussed, turning loops 115 may be provided to eliminate the need for left hand turns at intersections. After a vehicle 305 travelling on local road 110B-1 crosses intersection 225, the vehicle 305 may demerge onto a cell 409 of turning loop 115, after which the vehicle may eventually merge onto a cell 405-1 of expressway 105A-2. In this manner, the vehicle once again crosses intersection 105A-2 and continues travelling as if the vehicle travelling on local road 110B-1 had made a left turn at intersection 225. In some embodiments, turning loop 115 also facilitates vehicles making right turns at intersections. For example, cells 407 forming right turn lane 130 could be incorporated into loop 115.

Vehicles which are instructed to enter a right turn lane 130 or a turning loop 115 may be subject to a similar method of control for executing turns in either scenario. Vehicles 305 which are scheduled to make a turn may be instructed by a local controller to demerge from traffic to enter a right turn lane/loop through the execution of a demerging routine as discussed above. Once in the turning lane/loop, the vehicle can merely follow the defined control points (which may be provided by the local controller) which dictate a generally curved path of travel for performing the turn. Upon completion of the turn, the local controller may execute a merging routine to provide instructions for the turning vehicle to re-enter traffic.

### Traffic Control System

Embodiments of the present invention provide traffic control systems wherein vehicles are controlled by instructions from a central control system. Centralized control of an entire fleet of controllable vehicles may be performed by a central computer which is connected to all of the vehicles in the fleet by way of individual onboard vehicle controllers located on the vehicles. Advantageously, the central computer system may track the location of every vehicle in the system. The central computer system can also know future locations of each vehicle for which a trip has been scheduled in any upcoming time step. This information may be used to efficiently schedule point to point trips for users of the system.

The central computer may be responsible for coordinating and instructing individual vehicles within the fleet of vehicles to travel on certain routes based on any of a number of factors and criteria, such as customer destination, shortest travel time, and traffic volumes, as further described herein.

Centralized traffic control systems may comprise management subsystems, subsidiary controllers, and controllers in individual vehicles which operate together to carry out the coordinated flow of vehicles.

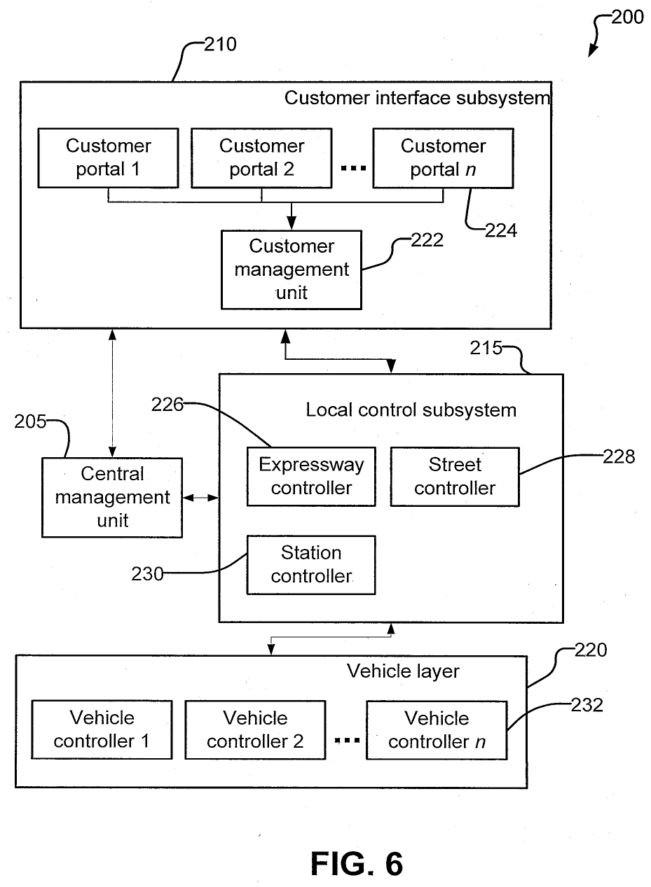

FIG. 6 is a diagrammatic representation of an example traffic control system 200 according to an example embodiment. As illustrated, system 200 comprises central management unit 205, customer interface subsystem 210, local control subsystem 215, and vehicle layer 220. Customer interface subsystem 210 is responsible for managing customer-facing systems, including the management of customer trip reservations and customer billing. Local control subsystem 215 is responsible for coordinating vehicle routes and for providing control to individual vehicle controllers.

Each constituent unit and sub-unit of control system 200 may record an audit log of activities under that particular unit's purview. For example, local control subsystem 215 may maintain a log of time-entries for which any vehicles enter an area under the purview of a street controller 228 at the particular entry location. The recorded location may be provided in the form of Cartesian coordinates, latitude and longitude coordinates, and/or a cell index, for example. Different units of control system 200 may be able to access the audit logs of other units in certain scenarios. For example, it may be desirable for a subsystem responsible for managing customer billing to be able to access a vehicle's travelled route at different local controllers to calculate an appropriate bill.

It will be appreciated that an immense amount of data may be logged during the operation of centrally controlled traffic schemes described herein. In preferred embodiments, software instructions are embedded in controllers to limit the transfer of data between constituent components of the system. Such a technique may be referred to as “Event Tact”. This technique comprises programming the constituent units of control system 200 to only send and receive filtered data to and from other units. The filtering avoids transferring data which is not essential to the operation of the part of the system to which the data is being transferred. For example, in some embodiments, the central controller is not generally required to have knowledge of vehicle positions in the system of interconnected roadways. However, if a significant vehicle malfunction occurs which requires action on the part of the central controller, such data may be communicated. Likewise, a vehicle herein can operate based on only having knowledge of an entry and exit point of relevant local controllers, locations where the vehicle should change lanes, and start/finish locations in stations, for example. Data transfer may therefore be limited of filtered such that vehicles receive only data that is necessary for operation, whereas other data, such as the locations of other nearby vehicles, can be omitted.

In preferred embodiments, techniques are applied to optimize computational processes in the traffic systems herein. For example, enhancing the computational speed of certain processes may enhance the safe operation of traffic system by being able to coordinate remedial actions as soon as possible. In some embodiments, a software technique of pairing inputs with outputs within a software module is applied for achieving this objective. This technique comprises mapping combinations of sensor inputs received at the module that correspond to certain known scenarios to appropriate outputs from the module. Such a mapping may be contained in a lookup table or another associative data structure, for example. In this manner, very few computations are required for arriving at a certain determination.

In the example where a motion detector camera detects that a vehicle has deviated by more than a threshold amount from an expected path a message may be automatically generated. The existence of the message may indicate to a local controller that certain corrective action is required. The local controller may automatically trigger the required corrective action based on the corrective action having been associated with the input message.

Different units within control system 200 may communicate with each other using any appropriate communication interfaces using wired or wireless networks. In some embodiments, appropriate API's may be defined developed for facilitating structured and efficient data transfer between different units of control system 200.

In some embodiments, the division and definition of management subsystems is based on a grouping of related tasks and/or on the similarity of the data critical for carrying out that task. For example, subsystems responsible for reservation systems for receiving customer transport requests may be grouped closely together with customer billing systems, as both of these systems rely heavily on customer data. Such groupings may comprise the use of common processing hardware, commonly shared databases, data communication interfaces, and user interfaces, for example.

Customer interface subsystem 210 comprises a customer management unit 222. Customer management unit 222 is responsible for managing customer-related information and for providing control over customer-facing applications. Customer facing applications may, for example, provide functionality for one or more of:
scheduling trips;
reviewing scheduled trips;
navigating to pickup locations for trips;
controlling access to stations or loading areas within stations;
accessing usage history and/or billing information;
maintaining a user profile;
etc.

Customer management unit 222 is shown to interface with central management unit 205 and local control subsystem 215. Customer management unit 222 may be responsible for coordinating customer trip requests with a scheduling controller (e.g. central management unit 205), providing updates on the status of past and on-going trips, and presenting and managing billing information for customers.

As discussed in detail below, customer interface subsystem 210 comprises a plurality of customer portals 224 which provide an interface for individual customers to interact with the transportation system herein.

In some embodiments, the use of and access to the transportation system described herein is provided free of charge to end users wishing to book travel or transport goods from one point to another. It is contemplated that embodiments of the transportation system herein may be the only means of transportation in a given metropolitan area. Thus, use of the transportation system herein may be completely funded by a municipal government or another local authority. In some embodiments, use of the transportation system is subsidized by a government whereby the end user must still pay of portion of the costs related to their use of the system.

In some embodiments, a billing subsystem records usage data such as one or more of:
a total number of kilometers travelled by all of the vehicles operating within the transportation system;
a number of trips taken by passengers;
a number of passengers carried;
average length of trip;
etc.
   in a given time period (e.g. a day, a week, or a month) and issues a bill to the municipality or other government authority based on the recorded usage data. In some embodiments, particular factors affect a rate associated with the use of vehicles. Such factors may include the particular type of vehicle selected for travelling a route, the types of routes travelled by vehicles and the time of day the vehicle travelled the particular route. In some embodiments (particularly where the customer bears a percentage of the costs), a total cost for a particular trip taken by a customer is presented to the customer. The cost for the trip may be calculated at the conclusion of the trip based on the completed route or the cost may accrue over the length of the route. The above factors and any other appropriate factors may be considered in determining the amount payable by customers.

Local control subsystem 215 may comprise sub-controllers responsible for directly controlling vehicles in logical and/or geographical subdivisions of the traffic control system. For example, as shown in FIG. 6, local control subsystem 215 comprises sub-controllers may include expressway controllers 226, street controllers 228, and station controllers 230.

Vehicle layer 220 comprises all of the vehicles travelling on interconnected roadway systems (such as roadway system 100) which are under the control of control system 200. Each individual vehicle within vehicle layer 220 comprises a vehicle controller 232. Vehicle controller 232 may comprise control hardware to guide the operation of vehicles herein (such as vehicles 305). For example, vehicle controller 232 may issue a torque signal to one or more motors of vehicle 305 to thereby control the vehicle's motion. Vehicle controller 232 further comprises a wireless data transmitter and receiver for communicating with local controllers and with a corresponding vehicle.

Since routes taken by the vehicles travelling on roadway system 100 are centrally controlled it is not necessary that vehicles 100 be capable of fully autonomous operation. The control systems of the vehicles may be relatively simple and may perform functions such as keeping a vehicle in a currently assigned allowed position 22 and executing instructions to change to different streams, enter stations etc.

Vehicles herein may comprise various sensors and monitoring instruments for providing information on the operating environment of the vehicle. In some embodiments, vehicles herein comprise a sensor or camera that reads markings (such as indicia that indicates the locations of control points 315) which indicate vehicle position and which may serve to inform certain vehicle operating parameters, such as to indicate a change in speed. In some embodiments, vehicles herein monitor their speed and/or positions based on wheel rotation data using a rotary encoder.

As an illustrative example and with reference to FIG. 5A, vehicle 305-7 detects an upcoming control point 315-7 which is spaced at a distance farther than a pair of control points 315 at a previous time step (e.g. control points 315-1 and 315-2). Accordingly, the controller 232 for vehicle 305-7 which receives this information provides instructions for vehicle 305-7 to increase its speed. Vehicle 305-7 may in addition or in the alternative receive information or commands from a local controller. The vehicle controller may use such information or execute such commands to keep the vehicle on the desired route and to keep the vehicle in the allowed position 22 allocated to the vehicle for a current part of the route.

The task of controlling a vehicle may be distributed in different ways between a controller of the vehicle and controllers of a centrally controlled traffic system. In some embodiments the control system of the vehicle provides only low level functions and all significant control input is coordinated by controllers of the traffic system. In other cases, the control systems of individual vehicles may themselves control the vehicles based on higher level instructions provided by the local controllers, particularly in the case where the locations of control points can be determined by the vehicles themselves (e.g. by means of physical indicia, signals, or location determination systems coupled with stored records indicating the locations of control points).

In the case that control points are virtually defined and provided to vehicles by way of local controllers, the local controllers may exert a higher degree of direct control over vehicle travel.

In some embodiments, vehicles comprise on-board diagnostic instruments and other sensors to provide an indication of the vehicles' status. For example, appropriate sensors may allow for metrics such as a vehicle's battery charge, tire pressure, operating temperatures of selected components, axle vibration, current draw, and various fluid levels to be communicated to a vehicle controller 232. Vehicle controller 232 may transmit such data to a corresponding local controller which may choose to instruct the vehicle to take remedial action if deemed necessary. A local controller may further communicate the vehicle's status to subsequent local controllers and/or to central management unit 205, for example, if the vehicle's systems are compromised.

Each of local controllers 226, 228 and 230 may comprise means of communicating with individual vehicle controllers 232 and/or various “smart infrastructure” elements dispersed throughout an interconnected roadway system 100. As an illustrative example, roadway system 100 may include motion detector sensors, cameras, pressure sensors, vehicle occupancy sensors, and the like. Controllers 226, 228 and 230 may comprise appropriate communication devices to receive signals from such sensors to accordingly control vehicles within the controllers' area of control based on the sensed signals.

Vehicles may be equipped with a wireless data transmitter for communicating signals sensed at the vehicles to a corresponding local controller. In this manner, local controllers 226, 228 and 230 may receive data regarding vehicles under their area of control from both the smart infrastructure sensing elements and from the vehicles themselves. In some embodiments, if discrepancies between these data sources are found, for example, in vehicle positional data, then the smart infrastructure readings may take priority over the vehicle-provided data.

Station controllers 230 may be provided at each passenger station 120, station controllers 230 may control the behaviour of vehicles located within corresponding stations. Generally, planned routes carried out by vehicles herein commence from a station 120. The successful execution of such planned routes may further depend on vehicles reaching various controllers along the vehicle's route at predetermined times, as discussed below. Therefore, station controllers 230 serve an important purpose in properly instructing a vehicle to begin its planned route at a scheduled time and to enter the area of control of a subsequent controller at a scheduled time. As discussed below, in some embodiments vehicles operating in stations 120 may operate semi-autonomously, and thus station controllers 230 may exert a lower degree of influence on vehicles as compared to other local controllers herein.

The delegation of control of groups of individual vehicles to sub-controllers may help to reduce data traffic, reduce latency in network communications between vehicles and responsible sub-controllers in control system 200, improve processing efficiency, and/or improve safety.

In some embodiments, as a vehicle is controlled to travel on a trip from a starting point to a destination point, control of the vehicle may be passed among two or more sub-controllers. For example, when the vehicle is in a station 120 to pick up a passenger the vehicle may be controlled by a station controller 230 associated with the station 120. Control of the vehicle may be transferred to a street controller 228 as the vehicle exits the station 120 onto a local road (e.g. local road 110). If the vehicle travels along the local road for a significant distance the control of the vehicle may be passed between street controllers 228 responsible for different parts of the local road. At some point the vehicle may be controlled to merge onto an expressway (e.g. expressway 105). Control over the vehicle may be transferred to an expressway controller 226 as the vehicle enters the expressway or a merging lane for the expressway. If the vehicle travels along the expressway for a significant distance the control of the vehicle may be passed between expressway controllers 226 responsible for different parts of the expressway at hand-off points along the expressway. As the vehicle leaves the expressway, control of the vehicle may be transferred to a street controller 228. Control of the vehicle may be transferred to a station controller 230 as the vehicle enters the destination station.

In such embodiments, each sub controller that is responsible for the vehicle for part of the trip may be configured to assume control of the vehicle at a specific time when the vehicle is at a specific location entering the area for which the sub controller is responsible and to deliver the vehicle at a specific time to a specific location leaving the area for which the sub controller is responsible.

Local controllers 226 and 228 may be referred to herein collectively as “road controllers” 226 and 228, as they control vehicles travelling on roads within a specific area of control. It will be appreciated that vehicles may enter and exit from the areas corresponding to road controllers 226 and/or 228 at multiple locations.

In some embodiments, areas corresponding to road controllers 226 and 228 are defined by functional boundaries. For example, an area of control for an expressway controller 226 may be defined as a length of expressway 105 spanning a number of city blocks, such as two to five. An area of control for a street controller 228 may comprise all local roads 110 within one or two city blocks, for example. A route selected for an individual vehicle by a central controller may specify which of these entry/exit locations will be used by the vehicle. This information may be used in efficiently scheduling vehicle routes, as discussed herein.

In some embodiments, different road controllers 226 and 228 are responsible for the control of vehicles in areas of the city which are overlapping. In other embodiments, adjacent areas controlled by two different road controllers 226 or 228 do not overlap. In some embodiments, there is an area between adjacent road controllers 226 or 228 for which no road controllers are responsible for providing control to vehicles travelling therein. In any of these cases, road controllers 226 or 228 may perform a handover procedure for vehicles leaving one controller's area to enter another controller's area.

In embodiments where the areas of control of two or more road controllers 226, 228 overlap, the two or more local controllers may simultaneously monitor and control vehicles in the overlapping area. In some embodiments, a hierarchy is assigned to each of the overlapping controllers which determines which controller's instructions and/or observations should take precedence in the case of a conflict.

In embodiments where there is a gap between adjacent areas controlled by different local controllers, vehicles within this gap may operate according to pre-determined instructions. For example, vehicles travelling in such a gap may operate according to a speed and direction dictated by known locations of control points (either physical or virtual) until the vehicles enter the area of coverage of a subsequent local which may provide further instructions to the vehicles.

In some embodiments, supervising controllers are provided to ensure that one or more local controllers (e.g. expressway controllers 226, street controllers 228 and station controllers 230) are operating according to the scheme specified by a central traffic controller (e.g. central management unit 205). Like local controllers, supervising controllers may cover a specific area defined by geographic and/or functional boundaries that are generally larger than that of local controllers. Supervising controllers may be considered to represent an abstraction layer between the local controllers and the central management unit 205, which may facilitate efficiencies in data transfer and in the delegation of tasks.

In some embodiments, supervising controllers oversee the handover of vehicles between two local controllers and provide override instructions (either directly to vehicles directly or to the local controllers) to take corrective action where appropriate. For example, where a vehicle enters an inbound controller's area of control at a time which is inconsistent with the inbound controller's schedule of expected vehicle entry times, the supervising controller may coordinate the revision of schedules for that controller and for subsequent controllers in that vehicle's route.

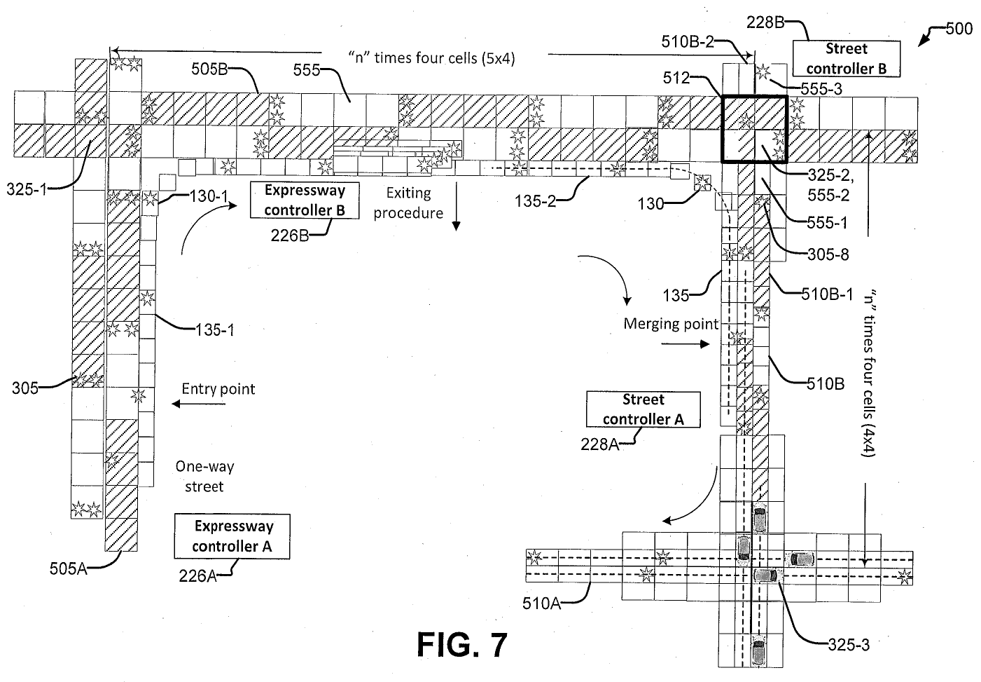

FIG. 7 illustrates an interconnected roadway system 500 according to an example embodiment. Roadway system 500 comprises expressways 505A and 505B and local roads 510A and 510B. As illustrated the control of vehicles 305 travelling on expressway 505A is assumed by controller 226A and the control of vehicles 305 travelling on expressway 505B is assumed by expressway controller 226B. Furthermore, street controller 228A assumes control of vehicles 305 on local road 510A and local road portion 510B-1 while street controller 228B assumes control of vehicles 305 on local road portion 510B-2. FIG. 7 further shows intersections 325-1, 325-2 and 325-3.

FIG. 7 illustrates an example scenario where there is a gap between areas controlled by adjacent local controllers. Different street controllers 228A and 228B are each responsible for different portions of local road 510B (local road portions 510B-1 and 510B-2, respectively). There is accordingly a gap 512 located at intersection 325-2 which represents an area of road 510B which is not controlled by either one of controllers 228A and 228B. As illustrated, vehicle 305-8 travels on the right-hand side of road 510B and travels upwards on the page (towards intersection 325-2).

As an illustrative example, cell 555-1, which indicates a possible location for a vehicle, may be considered to be the last cell within the area of control of street controller 228A. Cell 555-2 is located in intersection 325-2 and is the first cell in which vehicles travelling upwards on road 510B are in an area not controlled by a street controller.

Cell 555-3 may be considered to be the first cell within the area of control of street controller 228B. Thus, the locations of a number of successive control points are preferably known to vehicle 305-8 before vehicle 305-8 advances from cell 555-1 to cell 555-2. For example, controller 228A may wirelessly communicate a number of subsequent virtual control points or subsequent control points are semi-permanent physical indicia detectable by the vehicle.

In embodiments where locations of subsequent control points are wirelessly transmitted to vehicles that are transitioning between different local controllers, the outbound local controller (i.e. the local controller that is giving up control of the vehicle) may communicate to transitioning vehicles the locations of control points that are within that gap.

Optionally an additional number of control points (within the jurisdiction of an inbound controller—i.e. a local controller that is taking control of a vehicle entering its area of control from a gap) may be communicated to the vehicle by the outbound controller. This may be done to ensure a smooth handover to the inbound controller, for example, to avoid issues caused by latency when establishing a communication link between the inbound controller and the entering vehicle.

In some embodiments, multiple controllers are or can be responsible controlling vehicles travelling in the same area of an interconnected roadway system. For example, expressway controllers 226A and 226B may be jointly responsible for vehicles travelling in intersection 325-1. As illustrated, Expressway controller 226A is responsible for the control of vehicles travelling on expressway 505A before, during and after intersection 325-1. Similarly, controller 226B is responsible for vehicles on expressway 505B.

In some embodiments, vehicles travelling across an intersection in one direction may be controlled by a local controller while vehicles travelling across the intersection in another direction are not controlled by a local controller. For example, expressway controller 226B may control vehicles travelling on the entire length of expressway 505B. Accordingly, the gap 512 in controlled areas is applicable only to vehicles travelling through intersection 325-2 on local road 510B. Vehicles travelling through intersection 325-2 on expressway 505B remain under the control of expressway controller 226B. In such embodiments, the controller retaining controlling over an intersection may optionally monitor the travel of vehicles travelling in a gap between road controllers.

Certain measures may be employed to ensure that interference between wireless signals is avoided. In some embodiments, local controllers having overlapping or adjacent areas of control transmit and receive data to and from vehicles and other smart infrastructure over non-overlapping frequency bands. Additionally, in embodiments where multiple road controllers are configured to be part of a local or area network, providing dedicated computing resources to the controllers can decrease the likelihood that the controllers compete for shared resources. Any known methods for reducing or eliminating interference among communication signals of different local controllers may be applied.

FIG. 7 also illustrates a number of features that roadway systems may optionally provide. For example, roadway system 500 comprises one-way roads 135. One-way roads 135 may be provided beside other roads. One-way roads 135 may be used to facilitate merging and demerging (e.g. as discussed in relation to FIGS. 5C and 5D).

As illustrated, each of roads 505A, 505B and 510B comprises one-way roads 135 on one side of another road. It is also possible that one-way roads 135 are provided on both sides of any roads described herein. One-way roads 135 are shown to have a length substantially similar to that of adjacent roads 505A, 505B and 510B. However, this is not always required. One-way roads 135 can be provided for only a portion of the length of an adjacent road to complete a specified function, for example, to facilitate entry and departure from a station 120.

FIG. 7 shows right turn lanes 130 which facilitate right turns in the vicinity of intersections without disturbing the continuous flow of traffic across the intersections. As illustrated, right turn lanes 130 are continuous with one-way streets 135 and serve to connect one-way streets 135 belonging to different roads (see for example right turn lane 130-1 connecting one-way streets 135-1 and 135-2). However, this is not necessary and right turn lanes 130 can be provided without being connected to a corresponding one-way road 135. In some embodiments, one-way streets 135 facilitate access to passenger stations (e.g. station 120).

FIG. 7 illustrates the principle described above wherein phases of vehicle streams across city blocks are coordinated based on the number of control points provided between two intersections. In FIG. 7, coordinated streams of 4-unit long fields are shown by alternating hatched and unhatched cells 555. Thus, by providing a multiple of four cells between each intersection, the coordinated intersection crossing sequences described herein may be perpetually performed. As shown, expressway 505B comprises five sets of four cells 555 (5 fields) between intersections 325-1 and 325-2.

In some embodiments, on-the-fly modifications of control systems herein are implemented to address instantaneous demands. In some embodiments, the area of control of a first local controller may be reduced to provide more resources for controlling an area currently experiencing high traffic volume. Adjacent local controllers may correspondingly expand their areas of control to account for the reduced area of the first local controller.

In some embodiments, additional local controllers are provided on-the-fly to meet instantaneous traffic demands. For example, an additional local controller may be provided for supplementing a local controller experiencing traffic volumes above a threshold level. In some embodiments, the added local controller and the original local controller each individually control distinct portions of the original area of control. In other embodiments, both the added and original local controllers control the same area, but each controller may perform different functions and communicate with one another. For example, one controller may be responsible for providing vehicles instructions while the other is responsible for verifying vehicle positioning.

In some embodiments, additional central controllers can be added before the capacity of a current central controller is reached. The two or more central controllers may be responsible for scheduling a single trip request. The different central controllers may each be responsible for scheduling portions of requested trips within their own jurisdiction. The scheduled trip segments may then be aggregated between the central controllers to arrive at a single trip route and schedule.

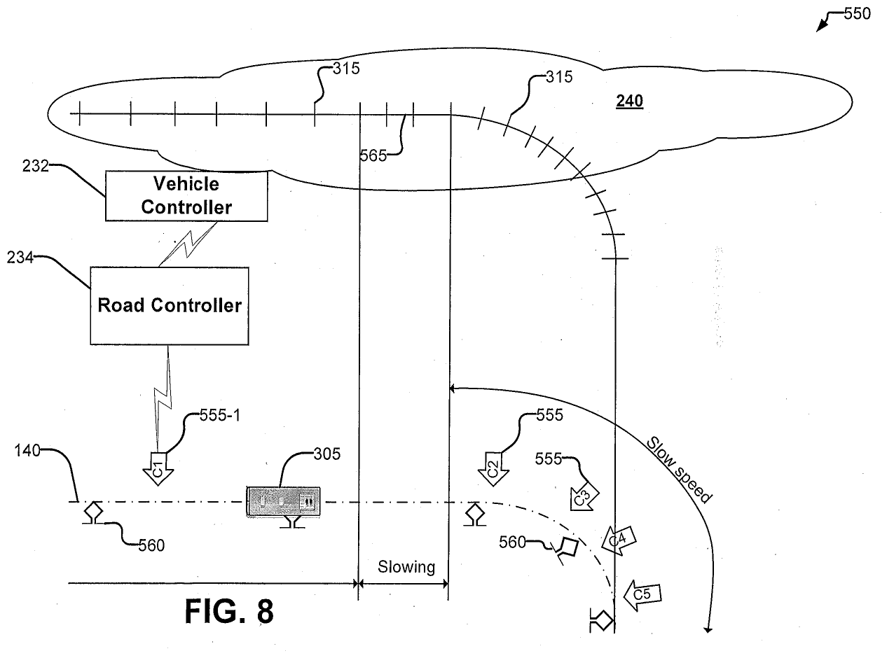

FIG. 8 illustrates an example traffic segment 550 showing example interactions between a vehicle and a corresponding local controller. Specifically, FIG. 8 shows an example of how vehicles can intermittently receive instructions from a corresponding local controller and be monitored by the local controller. Traffic segment 550 comprises a vehicle 305 travelling along a road 140 which is controlled by local controller 234. Road 140 may be an expressway 105 or a local road 110 and local controller 234 may be an expressway controller 226 or a street controller 228, for example. As shown, vehicle 305 wirelessly receives the locations of virtual control points 315 from local controller 234 upon local controller 234 verifying the position of vehicle 305 using motion detector camera 555-1. The virtual control points 315 define a path 565 and are stored in vehicle memory 240.

Control points 315 stored in vehicle memory 240 provide instructions for vehicle 305 to slow down in advance of a turn and to subsequently perform a turn according to the virtually defined path 565. A number of motion detector cameras 555 are shown. Local controller 234 may process images from cameras 555 to verify the adherence of vehicle 305 to path 565. A number of passive sensors 560 located on the road are provided. Passive sensors 560 allow sensors on vehicle 305 to detect whether vehicle 305 has deviated from expected positions on the road. In some embodiments, upon detecting a deviation, vehicle 305 may perform small corrections independently of local controller 234.

### User Interfaces

Customer portals 224 may be provided to allow individual customers to interact with a transportation system. According to a preferred embodiment, customer portals 224 comprise a downloaded application on suitable computing devices, such as smart phones. The application may provide a user interface which allows customers to make trip reservation requests. The user interface may prompt customers to enter certain required fields, such as a requested departure time (which could be the current time) and a destination. A pick-up location may be determined based on a customer verifying a current location obtained from the customer's device, or the customer may manually select a station 120 as the pick-up location. The customer may enter additional optional fields using the interface, such as whether additional passengers will be travelling, whether special accommodations are required or whether a particular vehicle type is desired, for example.

Optionally, customers making trip reservations have the option of entering an urgency for their trip request. Where a high priority or an emergency for the trip request is indicated by the customer, scheduling systems herein may assign a higher priority to that customer's trip request and may thus allow the scheduling of that trip request to take priority over the scheduling of other trip requests.

After a suitable route and schedule for carrying out the customer's trip request is found, the application may present this option to the requesting customer. The application may present the customer with a boarding time, a map showing the suggested route, and the scheduled arrival time at their destination. The customer may then be given the option of accepting this route or requesting another route. If confirmation of the route is given within a set period of time, the route is locked and the local controllers along the selected route are informed by the scheduling controller to reserve the appropriate time slots to accommodate travel on the reserved route. Where the customer does not provide confirmation of the route in the set period of time, the scheduling controller may automatically present another route and/or another arrival time to the customer, as the original schedule can no longer be fulfilled.

After a reservation has been made and confirmed, the customer application may provide instructions for the customer to proceed to a certain pick-up location in station 120 to wait for the reserved vehicle. During the trip, the application may allow the customer to view their trip status and may optionally allow customers to share their trip status with others through social networking and messaging applications.

As discussed later herein, access to certain parts of stations 120 may be controlled by a passenger's trip reservation status. In some embodiments, passengers use the customer application to verify their reservation status with sensors disposed at different locations in stations 120 to gain entry to those parts of station 120.

The customer application may further be connected to central systems responsible for customer billing and/or usage tracking. For example, the customer application may display an invoice for current reservations as well as a history of invoices for past reservations. The customer application may provide means for customers to pay, such as through entry of a customer's credit card number or other banking details. The customer application may additionally provide an interface for requesting customer support and for communicating with customer support representatives.

### Route Planning

In some embodiments a route for a trip between a starting point and an end point defines precisely a starting time for the trip, an ending time for a trip and where the vehicle will be in every time step between the starting time and the ending time. For example the route may assign a particular vehicle to provide the trip and may specify what field the vehicle will travel in on each stage of the trip as well as when the vehicle will be controlled to turn onto a different road, merge onto an expressway, etc.

From the point of view of a user on a scheduled trip, the route provides a fixed tunnel between the starting point and the ending point. The tunnel is made up of specific allowed positions 22 in one or more specific streams 25 that are reserved for the trip and which take a vehicle from a starting location at a specific starting time to an ending location. Unless there is a system malfunction this tunnel is guaranteed to be available to for the trip and the arrival time at the end of the trip is also guaranteed.

In this manner, vehicles travelling on planned routes are not required to be aware of or react to other vehicles. Each vehicle is controlled to stay in the sequence of one or more allowed positions that have been assigned to it.

An advantage of planning trips in a centralized traffic control system is that the traffic control system can plan the trip with a sure knowledge of what allowed positions 22 will be available to a vehicle that will provide the trip (since the fields are predefined and it is known what fields will be occupied at what times by other vehicles on already scheduled trips. Every trip may be optimized taking into account the current traffic situation.

### Example Route Planning Method

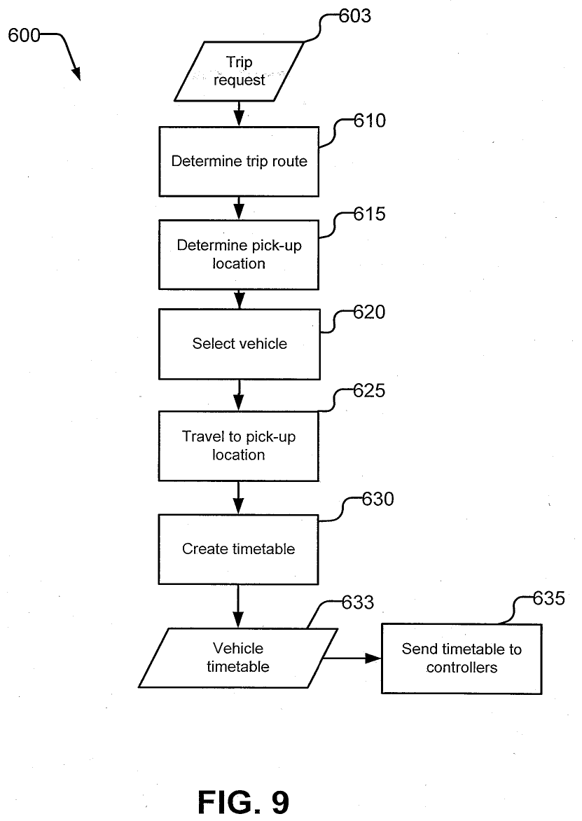

FIG. 9 illustrates an example method 600 for planning a vehicle route according to an example embodiment of the invention. Method 600 receives as input a customer's trip request 603 (e.g. from a customer portal 224). As an illustrative example, trip request 603 comprises the customer's starting location, the customer's target destination and a time when the customer wishes to commence the trip. Certain steps of method 600 are described as being performed by a scheduling controller. As discussed further herein, there are a number of suitable controllers which may be invoked in the scheduling of passenger trips, including, but not limited to, the opening station controller 230 and the central management unit 205.

Method 600 begins at block 610 where a controller determines a trip route which satisfies the customer's trip request 603. According to an example embodiment, block 610 first comprises determining an opening station and a closing station (e.g. stations 120) corresponding to the trip request 603. Following this, a number of possible routes for travelling from the opening station to the closing station along the interconnected roadway system are determined. The different possible routes may be selected such that a measure of similarity of the different routes is minimized. According to an example embodiment, five possible routes are selected at block 610. The selection of more or fewer route options is possible in other embodiments.

Based on a current spacing of control points on the roads for the various possible route options, the time required for the vehicle to reach its destination under ideal conditions can be determined for each option. In some embodiments, estimated travel times are based on historical traffic data. Generally, the route with the fastest travel time is selected as the trip route, although the consideration of other factors, such as the avoidance of toll roads or a priority of certain vehicles and/or passengers for travelling particular roads is possible. It may also be preferable to select a route which involves roads for which there are fewer ongoing or scheduled trips so as to distribute traffic evenly across the interconnected roadway system. In some embodiments, a customer may provide final confirmation for a selected trip route.

Method 600 proceeds to block 615 where the method determines a pick-up location for the customer at the opening station 120. The pick-up location may be based on a variety of factors, such as the vicinity of the customer to available pick-up locations, and whether the passenger has indicated that they have physical disabilities requiring special accommodation.

Method 600 then proceeds to block 620 where the method comprises selecting a vehicle for carrying out the customer's trip request. In some embodiments, the opening station controller 230 or any road controllers 226 and 228 in the vicinity of the station is queried to locate a vehicle that is available and which is appropriate for making the requested trip.

At block 625, both the passenger and the selected vehicle are instructed to travel to the customer pick-up location selected at block 615. Block 625 is completed when the passenger enters the selected vehicle at the pick-up location and confirms that they have done so and/or if the vehicle sends a confirmation that the passenger has entered the vehicle. At block 625, the local controller currently responsible for the selected vehicle may query its own timetable and that of any other intermediate controllers along the vehicle's route to the opening station for available time slots. The local controller may then subsequently reserve those slots to accommodate the vehicle's travel to the pick-up location.

Method 600 then proceeds to block 630 where the method comprises creating a timetable according to which subsequent local controllers along the selected route reserve specific allowed positions 22 for that vehicle at certain times. This timetable simultaneously restricts other vehicles from occupying or reserving the allowed positions 22 at the times that the vehicle is scheduled to occupy the allowed position 22. In some embodiments, block 630 further comprises determining appropriate instructions for vehicles to merge, demerge, or to enter a turning lane, at particular times and locations.

In some embodiments, local controllers maintain a timetable of vehicle locations within their areas of control. The timetable may comprise an indication of which allowable positions (such as allowed positions 22) within the controller's area of control are currently occupied (which may be based on observations of vehicles travelling on the road) or which are scheduled to be occupied at future times. In some embodiments, the timetable comprises entries for future times at every time interval according to the system time step. Thus, in such embodiments, the available times for which vehicles can be scheduled to enter the controller's area of control are known.

Furthermore, a scheduling controller may be able to obtain how much time is required for a vehicle to travel from an entry point of a local controller to an exit point of that local controller for the selected route based on that local controller's knowledge of roadway layouts and the positions of the local controllers' boundaries. The relevant local controller may make a determination of travel time for providing to the scheduling controller based on a number of the system parameters described herein, such as the spacing between control points and the system time step, for example. Accordingly, given an arbitrary starting time for which a vehicle enters a local controller's area of control, a scheduling controller may accurately obtain information on when the vehicle will enter the area of control of subsequent controllers along the vehicle's route.

According to an example embodiment, a local controller requires only a particular vehicle's entry time at an entry point to an area controlled by the local controller and the vehicle's route for determining and tracking that vehicle's position. The vehicle position at a given time P(t) may be tracked with the equation P(t)=P_{T}+f(t) where P_{T} is the vehicle's absolute position at the time of entry at the local controller and f(t) represents the travel of a vehicle on its scheduled route at a time of interest. f(t) may represent a number of control points (and thus distance), and any possible curvature on the vehicle's particular route. Thus, in some embodiments, the determination of whether other vehicles occupy particular positions on the road during scheduling comprises performing the above simple calculation for existing scheduled trips. In some embodiments, the above formula can be used for determining a vehicle's position from the starting point at a station by calculating the distance travelled by the vehicle along its route through areas controlled by one or more local controllers.

Thus, based on a selected route which satisfies the customer's trip request, the scheduling controller may query whether it is possible for a line of local controllers along the selected route to accommodate the vehicle leaving the station and commencing the selected route at a number of times. For example, the central controller may query whether all of the relevant local controllers can accommodate the travel of the vehicle from the specified opening controller to the closing controller, the vehicle departing in the next two, three, or four minutes.

Generally, the first available departure time that the line of local controllers can accommodate the vehicle will be selected. However, in some embodiments, a later time is selected, such as where an emergency occurs or where the scheduling of a higher priority vehicle must first be accommodated.

According to an example embodiment, evaluation of possible departure times may be performed in parallel for all of the cycle time steps within a given time frame. In the illustrative example embodiment where the cycle time step is 1 second and the time frame for which possible departure times are queried is 3 minutes, then up to 180 possible departure times may be evaluated.

If at any point a controller in the series of local controllers determines that another vehicle is scheduled to occupy a location required for completing the possible route at the departure time or the possible route cannot be otherwise satisfied, that particular departure time is eliminated from consideration for that possible route. An optimal starting time and route may then be selected from amongst the departure times for which it is possible to schedule a trip by any of the possible routes.

In some embodiments, the process of scheduling a customer's trip is performed in an iterative manner. For example, the first available time slot at the starting local controller for taking the scheduled vehicle to a certain exit point of the local controller is selected by the scheduling controller. The scheduling controller then evaluates whether the subsequent controller is able to accommodate the vehicle's expected entry and exit times in that subsequent controller's area of control. The scheduling controller may continue this process for all of the local controllers in the line of controllers until the vehicle reaches its destination.

However, where there is an inability to accommodate the vehicle at any of the local controllers, the process may restart from the opening local controller at a subsequent time step. This process may be repeated until a suitable starting time for completing the route is found.

The completion of block 630 yields vehicle timetable 633. In some embodiments, vehicle timetable 633 comprises a list of all of the allowed positions 22 scheduled to be occupied by the vehicle at specific times based on the selected route and departure time. Timetable 633 may comprise specific instructions to provide to vehicles (e.g. by way of local controllers) to merge, demerge, or to enter a turning lane, at particular times and locations. In other embodiments, only the times at which the vehicle enters the areas of different local controllers along the vehicle's route are recorded in timetable 633.

At block 635, the scheduling controller may communicate the vehicle timetable 633 to the various local controllers along the vehicle's route. As discussed, the timetable 633 received by local controllers may comprise the locations of the scheduled vehicle at all possible times (i.e. at intervals of the system time step) for which the scheduled vehicle is within that local controller's area of control, accompanied by vehicle instructions. The relevant local controllers may then update their timetable of vehicle locations within their area of control based on the scheduled times for the newly scheduled vehicle such that the same time/location combinations cannot be scheduled for subsequent vehicles.

Block 635 may further comprise communicating the vehicle timetable 633 to a central controller. In some embodiments, the central controller notifies the customer requesting the trip of the finalized timetable and route. In some embodiments, the central controller maintains a log of scheduled trips based on received timetables 633.

In some embodiments, the timetable that is maintained by the central controller comprises fewer times and locations for a given area of control as compared to a local controller which is responsible for that area. For example, records relating only to entry and exit times in that area might be maintained by the central controller while the local controller might maintain records relating to all allowable positions. In this manner, more granular control and supervision of a vehicle's travel along a route is delegated to the local controllers and the central controller is tasked with supervision of vehicle travel at a high level.

As discussed, the scheduling controller which may be invoked for performing various steps of method 600 can be one of a number of possible controllers. Without wishing to be bound by theory, it is believed that it is advantageous to delegate as much of the scheduling functions to “lower-level” controllers as possible such that route planning and optimization is performed using a “bottom-up” approach. According to an example embodiment, a central controller may receive a trip request and determine possible route options (blocks 603 and 610). After this point, the subsequent steps may be delegated to and be performed by lower-level controllers such that the central controller is free to manage other requests. In this manner, the central controller operates to receive customer requests and then delegate subsequent oversight of each route's execution to various local controllers. In some embodiments, multiple central controllers are provided wherein each central controller is responsible for routing trip requests in a certain area of an interconnected roadway system.

As an illustrative example of the bottom-up approach, the scheduling controller receiving the possible trip options may be the opening station controller or another local controller dedicated to route scheduling. The scheduling controller has the responsibility of performing and coordinating the remaining steps of method 600 until the schedule is finalized and ready to be communicated back to the central controller. As discussed, the route planning and optimization of routes may be managed directly between the scheduling controller and the relevant local controllers. The sourcing of vehicles required for making scheduled trips can also be performed at the level of the local controllers. By doing so, most of the computation and data transfer is delegated to and occurs between lower-level controllers, thus significantly increasing the computational efficiency of route planning for the centrally controlled traffic systems described herein.

It will be appreciated that any number of possible ways for forming a schedule according to which vehicles travel a given route are appropriate in practicing the present invention. For example, in other embodiments, a timetable comprising times at which a scheduled vehicle reaches entry points at all subsequent controllers along the vehicle's route is initially maintained by only the local controller at the beginning of the vehicle's route. As the vehicle travels along the planned route, the initial local controller passes the timetable to the subsequent local controller in the vehicle's route. Optionally, portions of the timetable representing portions of the route that the vehicle has already travelled may be deleted when communicating the remaining timetable to a subsequent controller, thus reducing data traffic and data storage requirements.

### Vehicles

As discussed above, vehicles are configured to be controlled by a central traffic control system. Individual vehicles do not need to have the same level of sensor systems or the same complexity of control systems that are required, for example, by autonomous self-driving vehicles. Individual vehicles include a communication system for receiving and sending data from and to the traffic control system and control systems for executing commands from the traffic control system (the commands may, for example, be executed to cause the vehicle to change speed, merge left/right, adjust its position, etc.). Except for in particular circumstances, discussed in detail below, individual vehicles are not required to be aware of their surroundings, including the presence of other vehicles.

Individual vehicles may have on board control systems that allow them to maintain a desired speed and road position (e.g. in a moving allowed position 22) without constant control applied by the traffic control system.

In some embodiments the control systems of individual vehicles are similar to the control systems of automated subway trains except that the vehicles provide steering control which trains running on tracks do not require.

Individual vehicles do not require controls that are operable by passengers. The passenger compartment of each vehicle may be entirely occupied by room for passengers to sit or stand and/or room for cargo. In some embodiments, space in certain vehicles is reserved for baby transport and mobility devices, such as strollers, wheelchairs and mobility scooters.

In some embodiments individual vehicles include sensors that assist in determining the position of the vehicle relative to a road. For example, the sensors may include sensors such as: one or more cameras that can image markings on or adjacent to roads; electromagnetic sensors that can detect electromagnetic signals such as may be emitted by an antenna such as a wire embedded in a road; a position sensor such as a GPS position sensor or an electromagnetic position sensor that detects a position of the vehicle in space; a radar sensor operative to detect surrounding objects or the like.

Control systems of the vehicle or of the traffic control system may use inputs from one or more such sensors to maintain a desired position of the vehicle relative to a road. In addition or in the alternative, traffic control system 200 may receive input from sensors outside of an individual vehicle that indicate the location of the individual vehicle, such sensors may, for example comprise: cameras, transponders, radar systems, short range data communication systems or the like.

In some embodiments the control system of each vehicle compensates for errors between the actual position of the vehicle at a specific time (as determined by the vehicle's sensor(s)) and a position at which the vehicle should be at the specific time according to commands from the traffic control system. In some embodiments the traffic control system compensates for errors between the actual position of the vehicle at a specific time (as determined by the cameras and/or other sensor(s) of the traffic control system) and a position at which the vehicle should be at the specific time according to the schedule for the vehicle. In case such errors are detected the traffic control system may generate and send to the control system of the vehicle a command indicating corrective action to take. The commands indicative of corrective actions may be executed by the vehicles' self-driving functions. In some embodiments, a maintenance subsystem can determine if vehicle malfunctions have occurred and can remove the vehicle from service, for example, in the case that vehicles are responding incorrectly to instructions.

Each individual vehicle can have outside dimensions small enough to allow the vehicle to fit entirely within an allowed position 22. In an example embodiment, each individual vehicle has a length and width that are both less than 4 meters. In some embodiments, vehicles can have dimensions allowing for two vehicles to fit side-by-side within an allowed position 22 with a buffer distance between the vehicles.

Vehicles may be electrically powered. In some embodiments the vehicles comprise batteries and the batteries are charged by battery chargers when the vehicles are at stations 120 and/or charged while driving on specific parts of roads by charging elements built into the roadway.

In some embodiments vehicles in the system include autonomous vehicles (AV) that have control systems that allow the AVs to be controlled by a traffic control system 200 and include any sensors required for detecting control points or verifying the position of the vehicle in the system. Such vehicles may be driven to a station that serves as an entry point for the system by a human driver and/or under autonomous control. At the entry point these vehicles may be locked in an operating mode in which they operate only under the control of the traffic management system. Such vehicles may subsequently leave the system by way as a station that serves as an exit point from the system. Such vehicles must not exceed allowed dimensions.

Before a vehicle is allowed to enter the system the vehicle may be subjected to and need to pass certain checks for safety and reliability. For example, the vehicle may be checked to ensure that:
Its control system can communicate with traffic control system 200 and be controlled by traffic control system 200—such a check may involve traffic control system 200 commanding the vehicle to perform certain manoeuvres;
The vehicle has sufficient power to reach its destination (e.g. batteries of the vehicle must be at least 80% charged);
The vehicle has passed a safety inspection; and/or
The vehicle has dimensions that do not exceed maximum dimensions.

If privately owned vehicles are allowed to operate in the system such vehicles may be treated differently from vehicles that are part of the fleet that is available to the public. For example, such vehicles may be only be given routes that start and end at either a vehicle storage facility with which the vehicle has been registered or an exit point from the system. For example the traffic control system may supply such a vehicle with a route from an entry point to the system to a certain station in the system that has a parking facility for private vehicles. On the other hand, the system would not provide to such a vehicle a route between two stations in the city that do not include parking facilities that will accept the private vehicle.

For the purposes of illustration, vehicles are illustrated herein as being electric vehicles. However other types of vehicles such as podcars, hovercraft, trucks, may operate on a system as described herein.

### Stations

Under the majority of circumstances, it is contemplated that vehicle controller 232 of each vehicle receives external instructions for operating the vehicle from a local controller (such as controllers 226, 228 and 230) or from externally provided information (the distribution of which may be centrally planned in a control room, for example).

Under some circumstances, vehicle controller 232 may operate corresponding vehicles in a semi-autonomous mode. In the semi-autonomous mode, a vehicle controller 232 is primarily responsible for operating a corresponding vehicle, as opposed to the vehicle control being managed by controllers external to the vehicle.

Operation of vehicles by vehicle controllers 232 may be guided by signals sensed at the particular vehicle. For example, vehicles herein may be equipped with sensors, such as radar, LIDAR, IR cameras, and the like for determining the vehicle's current position and for detecting obstacles. The semi-autonomous operation of a vehicle may be based on a high level instruction received from a local controller, after which the vehicle controller 232 autonomously controls the vehicle to perform the defined task. In other embodiments, autonomous driving features of vehicles in stations are leveraged only for making emergency stops or deviations for avoiding obstacles.

In some embodiments, vehicles in stations herein operate in a semi-autonomous manner. As an illustrative example, a station controller 230 may provide a parked vehicle an instruction to proceed to a selected passenger zone to pick up a passenger. The vehicle controller 232 corresponding to that vehicle may first instruct the vehicle to depart from a parking spot or other current location of the vehicle to travel to that passenger zone. During the vehicle's travel, vehicle controller 232 may employ readings from various sensors located at the vehicle to safely navigate to the destination.

In some embodiments, interim instructions may be provided to the vehicle from the station controller 230, which include making modifications to the vehicle's route based on the locations of other parked vehicles and the presence of other vehicles which will enter the vehicle's current path of travel. Upon arriving at the destination, the vehicle controller 232 can communicate to the instructing station controller 230 that it has completed this task, whereupon the vehicle awaits further instructions.

As discussed, a centrally controlled traffic system as described herein may control vehicles to travel according to set timetables, wherein adherence to the timetable is enforced by local controllers.

In some embodiments, after a vehicle picks up a passenger for a scheduled trip, the timetable according to which the vehicle should depart the station and commence its trip is determined by or is otherwise communicated to the station controller 230. The timetable comprises a time and location for which an opening street controller at the exit of the station expects the vehicle to be present. Accordingly, the station controller 230 may instruct the vehicle to travel to a location within the station in close proximity to the exit and wait until the scheduled time to depart the station and begin the scheduled route. In some embodiments, queueing areas for vehicles waiting to exit are provided near the exits of stations 120.

In some embodiments, stations 120 comprise access control measures. Such measures may be implemented to avoid crowding of people in stations 120 and at boarding zones. For example, access to certain areas of stations 120 may depend on whether customers have an active trip reservation or on the current status of their active trip reservation. For example, customers who do not have an upcoming reservation may be denied access at the entrance of stations 120. Customers who have an upcoming reservation but are scheduled for a trip departing at a later time may be allowed into a waiting area of station 120 while being restricted from entering other areas of the station, such as the passenger pick-up zones. Finally, when it is sufficiently close to a customer's scheduled reservation, the customer may be permitted to enter their assigned passenger pick-up zone. Verification of access rights may be performed by any suitable means, for example, through a mobile application used by customers for making trip reservation requests.

In some embodiments, stations 120 also serve as locations for storing vehicles which are not currently servicing an active trip request. Stations 120 may optionally comprise areas dedicated to storing vehicles awaiting deployment or which are presently out of commission.

In some embodiments, vehicles are distributed to areas where they are most likely to be needed. The distribution of vehicles may be based on historical traffic patterns to be able to most effectively serve areas where customer trip requests are most likely to originate from. In some embodiments, vehicles may be redistributed during times of off-peak activity, such as at night, so as to not congest current routes and trip scheduling. Vehicles may be distributed according to historical data on traffic patterns and volumes on different routes and areas at different times of the day.

### Freight Delivery/Special Traffic

A centrally controlled traffic system having features as described herein may carry commercial cargo or freight instead of or in addition to passengers. In some embodiments, vehicles are configured to carry commercial cargo or freight. The scheduling of freight vehicles may be centrally planned as in the case of passenger vehicles. For example, a business requiring freight or cargo to be delivered can make a trip request through a mobile application, similar to the case of passenger trip requests. A central controller may similarly schedule a trip using freight vehicles according to the scheduling methods described above (e.g. method 600).

In some embodiments, freight vehicles share the use of the same stations 120 as passenger vehicles. Stations 120 may be provided with dedicated commercial loading zones which are configured to accommodate the loading and unloading of freight or cargo containers. In some embodiments, dedicated stations are provided for commercial freight vehicles in order to optimize loading and unloading procedures and to separate such activity from regular passenger flow.

It is contemplated that freight vehicles may be longer and/or wider than passenger vehicles. A central controller scheduling routes for wide or long freight vehicles should consider such special attributes to appropriately schedule trips on roads which can accommodate that particular vehicle.

In some embodiments, freight vehicles which are wider can occupy allowed positions 22 which are wide enough to accommodate two regular side-by-side passenger vehicles (e.g. a single freight vehicle occupying the space occupied by vehicles 305-4 and 305-5 in FIG. 3). In this manner, a wide freight vehicle can be considered to travel in the same manner as aggregated vehicles described above. Additionally, freight vehicles may occupy a length which is longer than the distance defined between two control points. In such cases, a central controller may reserve two or more fields for accommodating a long vehicle. In some embodiments, portions of roads or routes may be temporarily blocked from being scheduled by the traffic control systems herein to permit dedicated freight vehicle travel.

For example, where fields are 4-units long (such as in the FIGS. 3 and 4 examples), a long vehicle may be scheduled to occupy two 4-unit fields. The scheduling of a long vehicle may further comprise prohibiting vehicles at cross roads from being scheduled immediately after the crossing of the long vehicle at intersections.

In some embodiments, scheduling commercial vehicle trips at night or when passenger travel volumes are low is incentivized. For example, lower rates may be charged, or a wider variety of available commercial vehicles may be available, to businesses who schedule trips at night.

### Safety

Some embodiments of systems as described herein are configured with emergency procedures, The emergency procedures may be invoked to handle emergencies, including, but not limited to, re-routing around the location of an incident, temporarily prohibiting new trip requests, granting higher priority to urgent trip requests and halting traffic to permit passage of emergency vehicles. In some embodiments, halting traffic comprises instructing vehicles to demerge onto shoulder or one-way roads.

As an example, where a traffic collision occurs on a road herein (e.g. as a result of a vehicle malfunction), a corresponding local controller may notify operators of a central control room of the incident. Thereafter, when scheduling trip requests, an operator may block that area of the road system from being scheduled until the control room operator receives confirmation that the accident has been cleared. In some embodiments, the operator instructs local controllers to reschedule the routes for vehicles currently obstructed by the collision and/or vehicles which are scheduled to travel through the collision area before addressing other pending trip requests.

### Example Passenger Volumes

As discussed, by coordinating traffic according to a centrally control scheme, vehicles are able to operate at higher average speeds and higher volumes of passenger traffic may thus be accommodated. With reference to expressway 505B in FIG. 7 in the area between intersections 325-1 and 325-2, five vehicle “fields” are shown. In the example where each time step is ¼ of a second and each cycle time step is 1 second, a vehicle entering this area takes five seconds to traverse across and leave this area of expressway 505B. If each available cell 555 is occupied by two vehicles travelling side-by-side in the same direction and each vehicle is able to seat four passengers, each direction of expressway 505B has a maximum achievable throughput of 480 passengers per minute or 960 passengers for both directions.

Such a throughput based off of only one small segment of an interconnected roadway is already higher than the maximum throughput of many conventional mass transit systems, such as subway or light rail transit systems. The transportation system described herein may easily scale using the principle of delegating control to various local controllers to thus accommodate significantly higher possible passenger volumes while requiring a significantly smaller investment in infrastructure.

### Simulation and Testing

Vehicles travelling in the transportation system herein are controlled to travel in specified allowed positions on dedicated roadways according to system-wide time steps, and in doing so, various efficiencies and benefits can be achieved for city-wide point-to-point transportation. A large number of factors may affect the performance of such a system including factors such as:
the locations of control points;
the length of time steps;
locations and capacities of stations;
the range of vehicles;
the design and capacity of turning loops and lanes;
the number of lanes per road; and
algorithms used for trip scheduling; etc.

Because of the vast interdependencies between components of the system and the costs involved in constructing a roadway network, it may be beneficial to perform tests using simulations prior to constructing and field testing a system as described herein. Some embodiments of the current invention include a simulator that allows operation of a transportation system as described herein to be simulated in a virtual environment which accurately mirrors a real-world implementation. Parameters such as those described above may be varied and tested in the virtual environment. For example, the simulation may be used to optimize:
field size;
locations of control points;
locations for vehicle charging systems;
designs and locations of stations;
designs and locations of streets in a street network;
control algorithms;
route selection algorithms;
algorithms for placing vehicles that are not currently in use;
etc.

In this manner, a real-world implementation of a transportation system design that has been thoroughly tested by simulation can be expected to perform as intended.

The simulation and eventual commissioning a transportation system as described herein is preferably performed in a number of phases to validate the proper functioning of the system. For example, implementation of the described transportation systems may comprise the following phases;
Phase I involves “happy path” testing where system inputs represent idealized data to verify the functioning of various operations and subsystems, the correctness of data sets, data interfaces, and the general functioning of any data processors involved, for example. The inputs at this stage may be fabricated and formatted in a way which reflects possible real-world inputs (such as inputs received from a customer management unit).
Phase II involves testing by receiving inputs which are manipulated so that the messages are received from external software modules and received/controlled by the test script. The data interfaces may be designed according to an Information Messaging Module, described below.
Phase Ill involves the testing of real-world infrastructure and control hardware for at least portions of the transportation system to be implemented. At this phase, a small number of testing vehicles are used to verify basic real-world operation of the traffic control systems and hardware.
Phase IV involves field testing, or beta testing, which is performed after the physical infrastructure of the transportation has been implemented.
Phase V involves commissioning wherein the installed hardware and vehicles are operated in a production environment which was tested in the previous phases. However, data is no longer manipulated by test scripts and depends solely on the interaction between real-world components.

The virtual environment may be provided by simulation software executing on a server or other suitable computer system. The simulation software may comprise a number of control modules which reflect the hierarchy of control described above. For example, virtual vehicle controllers which control virtual vehicles may be subsidiary to local controllers, which in turn may be subsidiary to a central controller. The functional relationships described above in relation to these components may be implemented in the simulation software. A system of interconnected roadways can be designed using the software wherein the roads allow other functional components of the simulation (such as vehicles and controllers) to interact with them. Cameras and other smart infrastructure may also be simulated in the software to provide verification of vehicle position and to provide monitoring.

Particular components of the virtual environment may interact with each other through an “Information Messaging Module”, or IMM. The IMM describes the use of software models which mimic the function and interaction of different components through exchanging packages of software messages and responses. For example, a simulated local controller module may be provided a list of expected messages from simulated vehicle modules concerning parameters such as vehicle speed, vehicle health, etc. Meanwhile, the vehicle module may expect certain messages and responses form the local controller module. The software module representing the various simulated components may provide external interfaces, such as an API, for communicating these sets of designed messages. By modelling communication between simulated components using the IMM and by including software modules representing different components of the traffic system where appropriate, a simulated environment can be easily defined and tested. The virtual environment may be operated using the same control software that is used for the real-world implementation, only with simulated data inputs/outputs. In this manner, the software for operating a smart transportation system can be readily implemented in a real world scenario once validated through testing.

After at least a portion of an interconnected roadway system has been defined in the simulation software, the system may be subjected to a simulation wherein vehicles operating according to set routes travel along the roadway system. Initial simulations may comprise testing the system under ideal conditions, or the “happy path” scenario.

It is important to employ simulations which reflect the non-ideal conditions and variability in real-world scenarios. Thus, a software module could be provided and invoked during various tests to provide fabricated data inputs to simulate non-ideal conditions. Testing of these non-ideal scenarios may comprise ensuring that proper corrective measures are taken by various components of the simulated system. A successful test case may comprise ensuring that an observable output corresponds to an expected behaviour given the testing input.

A first layer of testing may comprise testing whether local controllers are able to provide proper instructions to vehicles within the controllers' area of control in certain non-ideal scenarios. For example, inputs representing poor road and weather conditions may be used. Furthermore, inputs representing invalid vehicle inputs to simulate vehicle malfunction may be used. The success criteria of such testing may comprise confirmation that the relevant controllers have taken proper remedial action in response to such inputs.

In some embodiments, the observable output in these tests is a vehicle behaviour that is detectable by the simulated smart infrastructure. Although adjustments may be made by vehicle controllers and/or local controllers under such testing scenarios, only the observable operating parameters of vehicles are used in verifying the success of the test cases. In other embodiments, the output used for verifying success of test cases comprises verifying that a valid software instruction is provided by the simulated controllers.

Another layer of testing a simulated environment may comprise testing the proper functioning of virtual hardware components in the simulated environment. For example, the response of the simulated environment to various hardware failures may be tested. In some embodiments, such test scenarios comprise simulating a controller malfunction. A successful test response may comprise verifying the functioning of failover systems to allocate extra resources and/or to re-assign adjacent controllers to assume the functions of the malfunctioning controller.

A subsequent layer of testing may comprise integrating different software modules and ensuring that the integrated modules function properly. For example, an integration test scenario may comprise verifying that a number of vehicles travelling in a certain area all operate according to given instructions. Non-ideal inputs may be added to test the robustness of the control software in addressing complications while maintaining coordinated traffic. An example test may comprise adjusting a position of every second vehicle such that their observed positions fall outside an expected range wherein a successful test response comprises verifying that the proper corrective procedures are taken.

The use of a data-driven testing methodology provides advantages in testing simulated transportation systems herein. By employing a table of test input conditions and verifying expected outputs, the defined test cases are not constrained to any particular simulation scenario. Thus, a single test suite can be re-used for testing across distinct transportation systems designs, requiring only little or no modification. For example, only the locations of memory addresses and the database representing the parameterized traffic system may require changing when testing different transportation system designs using the same data-driven test suite.

Because of the vast number of scenarios that may require testing to ensure the proper functioning of traffic systems herein, the automatic generation of test scripts is advantageous for achieving a high degree of code coverage without requiring excessive resources. In some embodiments, a software module for generating test scripts can receive a set of expected outputs corresponding to a given a set of inputs. The software module may then generate a testbed for testing that the set of inputs cause the simulated system to produce the set of expected outputs to thus validate the design of the simulated system.

In some embodiments the simulation software is accessible online to testers, who may be members of the public who may use the virtual environment to schedule trips. The simulation software optionally provides simulated video images in a video game environment that allow the testers to experience taking trips in the virtual environment.

### Implementation

Following successful testing in the simulated environment, the implementation of a transportation system of the present invention in a real-world environment can be accomplished in a number of possible ways. According to an example embodiment, the real-world implementation comprises two phases. In a first phase, the travel of vehicles operating according to system commands in an open area is tested. In a second phase, physical features of interconnected roadway systems are incrementally added and tested.

The first implementation phase may comprise providing a number of vehicles in a large open area. The vehicles may be instructed to travel in the open area according to a centrally controlled scheme without any actual city infrastructure. Using virtually defined control points, as discussed above, the vehicles are treated as travelling on defined roads in a select area of the designed roadway system. Operators and testers overseeing this implementation phase may be able to adjust system parameters (e.g. changing road layouts) and to introduce faults in order to test the robustness of the implemented system. After the implementation and testing of the first phase is deemed satisfactory, the implementation may proceed to the second phase.

The second implementation phase may comprise implementing physical features of the roadways. This implementation phase may be done incrementally, wherein physical areas of the interconnected roadway system are added and tested upon the successful testing of a previously added area. In this phase, mock trip routes may be provided to vehicles, wherein the vehicles' performance of the route from opening stations to closing stations according to the set schedules is assessed.

Upon adding all of the physical and control elements of a designed interconnected roadway system and verifying that all of the designed traffic routines are being properly executed, the system may be made available for customer use.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Embodiments of the invention (for example a traffic control system, controllers in vehicles, local controllers, road controllers, expressway controllers, scheduling controllers etc.) may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channels.

Methods as described herein may be varied. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, in some cases while processes or blocks are at times shown as being performed in series, these processes or blocks may instead be performed in parallel, or may be performed at different times.

Some aspects of the invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

Where a component (e.g. a software module, controller, vehicle, sensor, processor, assembly, device, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. A transportation system comprising:
a plurality of interconnected roads;
a plurality of vehicles travelling on the plurality of interconnected roads, the vehicles capable of being controlled by one or more remote controllers;
a plurality of allowed positions located on the plurality of interconnected roads, each of the plurality of allowed positions followed by a forbidden zone;
wherein, in the vicinity of an intersection of two or more individual roads of the interconnected roads, one or more of the remote controllers control the plurality of vehicles to occupy an allowed position and wherein the one or more remote controllers control the allowed positions, vehicles and forbidden zones to advance a distance every time a system time step elapses.

2. The traffic system of claim 1 wherein the positions of allowed positions are coordinated so that when an allowed position is located in the intersection at a given system time step, other intersecting roads have a forbidden zone in the intersection.

3. The traffic system of claim 2 wherein each of the vehicles travelling in the intersection travel at the same speed.

4. The traffic system of claim 1 wherein the forbidden zones are longer than the allowed positions.

5. The traffic system of claim 4 wherein each pair of neighbouring allowed positions and forbidden zones form a field which is four units long, the allowed positions being one unit long and the forbidden zones being three units longs.

6. The traffic system of claim 1 comprising a plurality control points spaced apart along each of the roads, the plurality of control points defining start and end points of each of the allowed positions and the forbidden zones.

7. The traffic system of claim 6 wherein a distance between adjacent ones of some of the plurality of control points is smaller than a distance between adjacent ones of other ones of the plurality of control points.

8. The traffic system of claim 7 wherein the distance between adjacent control points depends on a speed at which vehicles in allowed positions at those control points are desired to travel.

9. The traffic system of claim 1 comprising a scheduling controller for receiving requests for transport, each of the requests for transport having a starting point and a destination.

10. The traffic system of claim 9 wherein the scheduling controller has knowledge of scheduled trips in the traffic system, and upon receiving a request for transport, the scheduling controller assigns a vehicle to carry out the request at a start time for which the assigned vehicle can be assigned allowed positions along a route from the starting point to the destination such that the assigned allowed positions are not fully occupied by other vehicles in subsequent time steps along the route.

11. The traffic system of claim 1 comprising a plurality of right turn lanes, the right turn lanes located away from the intersection and configured to allow vehicles to make right turns in the vicinity of the intersection without entering the intersection.

12. The traffic system of claim 1 comprising a plurality of turning loops, the turning loops located away from the intersection, wherein vehicles can be controlled to turn right at a turning loop following an intersection and to turn right again at an intersection of the turning loop with a cross road from the intersection.

13. A traffic system according to claim 1 comprising one or more expressways and one or more local roads, wherein vehicles travelling on expressways are configured to travel at a speed faster than a speed of vehicles travelling on local roads.

14. The traffic system of claim 1 comprising passenger stations wherein vehicles travelling in the passenger stations operate at least partially autonomously to receive and deliver passengers.

15. The traffic system of claim 1 wherein two or more vehicles are controlled to occupy a single allowed position.

16. The traffic system of claim 1 wherein vehicles which are controlled to merge onto a lane of vehicle traffic do not advance the same distance at every system time step as vehicles already travelling in the lane.

17. The traffic system of claim 16 wherein vehicles which are controlled to merge onto a lane of traffic temporarily occupy an area in a forbidden zone.

18. The traffic system of claim of claim 1 wherein the one or more remote controllers verify an adherence of the plurality of vehicles to assigned allowed positions using at least one of:
motion detector cameras;
pressure sensors;
vehicle occupancy sensors;
passive road sensors; and
electromagnetic sensors.

19. A method for scheduling transportation requests, the method comprising:
receiving, by a central controller, a transportation request from a user;
determining one or more possible routes for fulfilling the transportation request;
transmitting, by the central controller, the transportation request to a scheduling controller; and
determining, by the scheduling controller for at least one of the one or more possible routes, a schedule for completing the possible route, wherein determining the schedule comprises:
determining a sequence of local controllers defining areas through which a vehicle travels for completing the possible route;
determining whether the sequence of local controllers can accommodate the travel of the vehicle along the possible route at one or more departure times, wherein determining whether the sequence of local controllers can accommodate the travel of the vehicle comprises, for each of the one or more departure times
sequentially querying, by each of the local controllers in the sequence of local controllers, a timetable to determine the possibility of accommodating travel of the vehicle through an area of the local controller based on at least an entry time of the vehicle, wherein:
if travel is determined to be possible, the method comprises determining an exit time for travelling a portion of the possible route through an area of the local controller;
if travel is determined to not be possible at one of the local controllers, the method comprises eliminating the departure time from consideration; and
the entry time at a first controller of the sequence of local controllers is based on at least the departure time and the entry time of a subsequent controller of the sequence of local controllers is based on at least the exit time of a preceding local controller;
amending the timetable to reflect the entry and exit times at each of the local controllers in the sequence of local controllers based on one of the departure times for which for the possible route can be accommodated.

20. The method of claim 19 wherein the timetable comprises a plurality of timetables, each of the timetables corresponding to a local controller in the sequence of local controllers.

21. A method for optimizing data processing and testing, the method comprising the steps of:
programming one or more of a plurality of constituent units of a software control system to send and receive filtered data to and from other ones of the plurality OF constituent units, the filtered data being data which is considered essential between the units in communication;
mapping one or more expected inputs of one or more of the constituent units to one or more corresponding outputs and storing the mappings in a data structure available for retrieval wherein the one or more constituent units are configured to arrive at one or more determinations by querying the mappings;
defining software interfaces which mimic the function and interaction of each of the one or more constituent units of the control system, wherein the software interfaces reflect data communicated by real-world hardware corresponding to each of the one or more constituent units;
generating software test cases based on at least the software interfaces and the expected inputs and outputs of the one or more constituent units.

22. A method comprising any step, act, combination of steps and/or acts or subcombination of steps and/or acts as described herein.

23. Apparatus comprising any feature, element, means combination of features, elements, and/or means or subcombination of features, elements, and/or means as described herein.

24. A vehicle as described herein.

25. A control system for a traffic system as described herein.

26. A local controller, expressway controller, street controller, station controller, central management unit or customer-interface subsystem as described herein.

27. A method or apparatus for route planning as described herein.
